(19) United States
(12) Patent Application Publication
(10) Pub. No.: US 2022/0343328 A1
(43) Pub. Date: Oct. 27, 2022

(54) SYSTEMS AND METHODS FOR QUALITY CONTROL RELATED TO NFT PURCHASE

(71) Applicant: Digital Seat Media, Inc., Fort Worth, TX (US)

(72) Inventors: Cameron Fowler, Fort Worth, TX (US); Matthew Sullivan, Austin, TX (US)

(21) Appl. No.: 17/660,677

(22) Filed: Apr. 26, 2022

Related U.S. Application Data
(60) Provisional application No. 63/269,015, filed on Mar. 8, 2022.
(60) Provisional application No. 63/201,373, filed on Apr. 27, 2021.
(60) Provisional application No. 63/201,376, filed on Apr. 27, 2021.

(51) Int. Cl. G06Q 20/40

(52) U.S. Cl. CPC G06Q 20/4015; G06Q 20/405

(57) ABSTRACT

A system for verifying a user device and obtaining the right to purchase an NFT comprising: a server system comprising at least one server, at least one database, and at least one user device; populated on said server system are a plurality of operable rules wherein said operable rules are met by actions performed by scanning by the user device one or more tags positioned within a geofence; defining at least a first rule wherein said user device confirms ownership of a ticket corresponding to a first tag by sending a request to the user device to identify a digital record matching the tag ID; verifying a location by determining whether the scan by the user device of the first tag was within the geofence; and redirecting the user device to a page selling or offering for sale the NFT.

### CROSS-REFERENCE TO RELATED APPLICATIONS

This application claims the benefit of U.S. Provisional Patent Application No. 63/269,015 filed on Mar. 8, 2022, U.S. Provisional Patent Application No. 63/201,373 filed on Apr. 27, 2021, and US Provisional Patent Application No. 63/201,376 filed on Apr. 27, 2021, all with the United States Patent and Trademark Office, the contents of which are incorporated herein by reference in their entirety.

### FIELD OF THE INVENTION

The present invention relates generally to methods and systems that use tags for engaging with a non-fungible token (NFT). The present invention also relates generally to methods and systems that use tags to enable the creation of an NFT, purchase of an NFT and electronic delivery of an NFT created by accessing or scanning an encoded tag located in, on, or near a point of interest.

### BACKGROUND OF THE INVENTION

The advent of distributed ledger systems has led to the creation and collection of Non-Fungible Tokens (NFTs), which are unique tokens related to certain subject matter whether it is physical or digital. For example, NFTs have been created for physical artwork, digital images of artwork, digital artwork, video, imager or other subject matter data. In certain instances, NFTs are created to signify and relate to ownership of the subject matter created by or sold by an individual or an entity. In other instances, the NFT itself is merely a unique digital asset. Thus, the NFT is a single, unique token that may or may not be related to certain subject matter, and in many cases can be utilized to signify ownership of, or other rights in, the same.

NFTs however, have not found use in all mediums and there are new and useful ways in which an NFT can be utilized to capture of a moment of time, or of ownership subject matter related to a particular location at a given moment in time. Herein, are described an elegant solution of systems and methods related to the acquisition and/or the use of NFTs in response to scanning a tag associated with a point of interest to enable the creation and/or purchase of, or interaction with, NFTs.

### SUMMARY OF THE INVENTION

The embodiments herein are directed to various systems and methods, specifically to interact with and afford the opportunity to create, purchase, or bid on Non-Fungible Tokens (NFT) by scanning a tag within the system. The NFT may then identify a point of interest, whether that be the actual location, an issue happening at that location, or some other information pertaining to that point of interest, an event, a moment in time related to an event, a program, a storage of digital media, a ticket, or a memorabilia related to a particular point of interest or event.

In a preferred embodiment, a system for verifying a user device and obtaining a right to purchase an NFT comprising: (a) a server system comprising at least one server, at least one database, and at least one user device; (b) populated on said server system are a plurality of operable rules, wherein said operable rules are met by actions performed by scanning, by the user device, one or more tags positioned within a geofence within a venue; (c) defining at least a first rule, wherein said user device confirms ownership of a ticket corresponding to a first tag, said first tag comprising a tag ID defining a specific seat within the venue; wherein the user device confirms ownership by the system after receiving a scan of the first tag by the user device and sends a request to the user device to identify a digital record matching the tag ID; (d) upon meeting the first rule, verifying a location by determining whether the scan by the user device of the first tag was within a geofence corresponding to the venue; and (e) upon verifying the location, redirecting from a server a URL or a Web app to the user device to a page selling or offering for sale the NFT.

In a further embodiment, the system wherein a further rule is required to receive the redirection in step (e), wherein the rule requires that the digital record confirms purchase of a season ticket to the seat.

In a further embodiment, the system wherein a further rule is required to receive the redirection in step (e), wherein the rule defines that the redirection is only available within the first x minutes after an event-related occurrence. In a further embodiment, the system wherein x minutes is between 1 minute and 60 minutes. In a further embodiment, the system wherein the event-related occurrence is selected from the group consisting of: a point scored, a game related event, the start of a game, the finish of a game, an occurrence by a given player within a game, scanning by a predetermined number of users of at least one tag within the venue, scanning by a predetermined number of users of at least one tag within the venue wherein the predetermined number of users are active on the system at a given time point, scanning of at least two tags by the user device, scanning of at least two tags wherein each of said two tags are positioned within a different geofence, purchase of an item through the system, placement of a wager on the system, and combinations thereof.

In a further embodiment, the system further comprising a graphical user interface (GUI), said GUI defining at least two tags positioned on a visual map on said GUI, wherein the rule requires a user to scan the at least two tags defined on said GUI to receive the redirection.

In a further embodiment, the system wherein the NFT comprises a digital image, wherein the digital image within the NFT comprises an operable tag comprising a machine-readable code.

In a further embodiment, the system wherein ownership of the NFT affords a benefit to a user owning the NFT, said benefit selected from the group consisting of: free beverages or food, special rights or entry, specific seat upgrades, backstage access, discounts to tickets, merchandise, other materials at the venue, wagering discount, and other tangible benefits that may be given by a proprietor at a given venue.

In a preferred embodiment, a method for authorizing purchase of an NFT comprising: (a) scanning, via a user device (14a), a tag (16a) comprising a machine-readable code (MRC) (17a); (b) verifying a unique ID (22a) on said user device (14a) or generating a unique ID (22a) if one is not present; and (c) directing the user device (14a) to a target URL for purchase of an NFT.

In a further embodiment, the method wherein the tag (16a) comprises a unique tag ID that identifies a seat within a venue. In a further embodiment, the method further comprising a verification step selected from the group consisting of: verifying ownership of a ticket corresponding to the tag (16a), a time verification, a geolocation verification, a predetermined threshold defined by an administrator, and combinations thereof.

In a further embodiment, the method further comprising a verification step, wherein upon scanning the tag (16a) in step (a), a server confirms the presence of a digital record corresponding to ownership of a ticket corresponding to the unique tag ID. In a further embodiment, the method wherein the verification step comprises wherein a server performs an API call to a third party to obtain a digital record confirming ownership of a ticket matching seat information for said tag ID, wherein the digital record is selected from the group consisting of: a digital ticket, a phone number, a credit card, an address, a name, a birthday, another personally identifiable information, and combinations thereof. In a further embodiment, the method further comprising matching a unique tag ID with a physical ticket.

In a preferred embodiment, a method for purchasing an NFT from a tag (16a) comprising: (a) scanning, via a user device (14a), a tag (16a) comprising a tag ID, said tag (16a) positioned on a seat and comprising a tag ID identifying said seat; (b) verifying a unique ID (22a) on said user device (14a) by requesting from a server a matching unique ID within a database or generating a unique ID (22a) if one is not present; (c) verifying ownership of a ticket on said user device (14a), said ticket matching the seat defined by said tag ID; and (d) directing the user device (14a) to a target URL for purchase of an NFT.

In a further embodiment, the method further comprising a verification step selected from the group consisting of: a time verification, a geolocation verification, a predetermined threshold defined by an administrator, and combinations thereof.

In a further embodiment, the method wherein the step of verifying ownership of a ticket on said user device is performed wherein upon scanning the tag (16a) in step (a), a server confirms the presence of a digital record corresponding to ownership of a ticket by a digital record stored on said user device corresponding to the seat and the tag ID.

In a further embodiment, the method wherein the step of verifying ownership of a ticket on said user device is performed by utilizing an API call to match a digital record on the user device (14a) to an authorization for the ticket at the given tag (16a), wherein the digital record is selected from the group consisting of: a digital ticket, a phone number, a credit card, an address, a name, a birthday, another personally identifiable information, and combinations thereof.

In a further embodiment, the method further comprising: (c2) determining that the user device is within a predetermined geofence. In a further embodiment, the method further comprising: (c2) confirming the presence of a first scan of a tag corresponding to a tag ID and performing a second scan of the same tag on a different day than the first scan.

In a preferred embodiment, a method for authorizing minting of an NFT by scanning a tag (16a) comprising: (a) performing a user scan by scanning, via a user device (14a), a first tag (16a) comprising a tag ID; (b) verifying, via a server and a database, a record for a unique ID (22a) having a corresponding matching unique ID on said user device (14a) or generating a unique ID (22a) if one is not present; (c) verifying that the user device (14a) comprises ownership of a ticket corresponding to the tag ID; (d) determining that the first tag (16a) is present at a venue wherein an event is being held at the time of the user scan; (e) determining, from a counting mechanism, whether at least x number of additional user devices have scanned a second tag at the venue within a predetermined amount of time before or after the user scan; (f) redirecting at least one user device having scanned the first or second tag at the venue to a target URL to award a right to mint an NFT; and (g) minting an NFT by creating a record within a distributed ledger.

In a further embodiment, the method wherein the step of verifying ownership of a ticket on said user device is performed wherein upon scanning the tag (16a) in step (a), a server confirms the presence of a digital record corresponding to ownership of a ticket by a digital record stored on said user device corresponding to a seat and the tag ID.

In a further embodiment, the method wherein the step of verifying ownership of a ticket on said user device is performed by utilizing an API call to match a digital record on the user device (14a) to an authorization for the ticket at the given tag (16a), wherein the digital record is selected from the group consisting of: a digital ticket, a phone number, a credit card, an address, a name, a birthday, another personally identifiable information, and combinations thereof.

In a preferred embodiment, a method for verifying a right to purchase an NFT by confirmation of attendance at an event based upon location comprising: (a) receiving a request from a user device for purchasing an NFT, the request received in response to scanning a machine-readable code with the user device, the machine-readable code corresponding to a tag disposed on a surface at an event, said tag having a tag ID; (b) in response to receiving the request and based on the tag ID, determining if the tag that was scanned by the user device has a matching digital record within the user device confirming the right to that tag ID; (c) in response to a confirmation that the matching digital record exists, confirming a location within a geofence corresponding the event; and (d) based on the determining and confirming of location steps, redirecting the user device to a portal offering the NFT for sale.

In a further embodiment, the method further comprising: (c2) wherein the NFT is only available upon an event-related occurrence; and redirecting the user device to the portal offering the NFT for sale only in response to the event-related occurrence.

In a preferred embodiment, a method for determining ownership of a seat for obtaining a right to bid on or purchase an NFT comprising: (a) scanning, via a user device (14a), a tag (16a) positioned on a seat, said tag comprising a tag ID identifying the seat; (b) verifying a unique ID (22a) on said user device (14a) by confirming the presence of a database entry containing the unique ID; (c) requesting to a server to confirm the presence of a digital record providing ownership information corresponding to said tag ID by searching a digital wallet (24a) for the presence or absence of the digital record; and (d) comparing the digital record to the tag ID and confirming ownership where said digital record and said tag ID confirm a matching record wherein, if no matching record is located, a subsequent search for ownership is performed.

In a preferred embodiment, a method for determining ownership of a seat for purchase of an NFT comprising: (a) scanning, via a user device (14a), a tag (16a) comprising a tag ID, said tag ID comprising seat information; (b) verifying a unique ID (22a) on said user device (14a) or generating a unique ID (22a) if one is not present; (c) performing a search to confirm a record providing ownership corresponding to the tag ID selected from the group consisting of: (i) directing the user device (14a) to a server to confirm the presence of a digital record providing ownership information corresponding to said tag ID by searching a digital wallet (24a) for the presence or absence of a digital record and comparing a digital record to the tag ID and confirming ownership where said digital record and said tag ID confirm a matching record; (ii) searching a paper ticket for a record corresponding to said tag ID; and (iii) performing an API call to a provider of said paper ticket and confirming at least one piece of personally identifiable information selected from the group consisting of: name, date, birthdate, credit card number, address, phone number, other personally identifiable information, and combinations thereof; and (d) upon location of a record providing ownership, authorizing the purchase of an NFT.

In a further embodiment, the method further comprising a verification step selected from the group consisting of: a geofence, a time, a predetermined limitation, and combinations thereof.

In a further embodiment, the method wherein the purchase is related to an NFT from a sporting event.

In a further embodiment, the method wherein the purchase is related to an NFT from a venue.

In a further embodiment, the method wherein the purchase is related to an NFT from a music event.

In a further embodiment, the method wherein the NFT provides unique access; said unique access selected from the group consisting of: free beverages or food, special rights or entry, specific seat upgrades, backstage access, discounts to tickets, merchandise, other materials at the venue, special discounts related to wagering, and other tangible benefits that may be given by a proprietor at a given venue.

In a further embodiment, the method wherein the NFT comprises rights to a unique digital image, and wherein the unique digital image comprises a tag, said tag comprising a unique tag ID; wherein scanning of the unique tag ID redirects a user to Web page that provides a tangible benefit.

In a further embodiment, the method wherein the right to purchase the NFT is provided based upon scanning a predetermined number of tags, wherein the predetermined number of tags are identified by a plurality of clues in a scavenger hunt.

In a further embodiment, the method wherein a counting mechanism is required to determine if x number of people are online at a given moment, and upon a given number of people being online at the moment, generating a lottery to select a winner of the NFT from the people online at the moment.

In a further embodiment, the method wherein a map of required tags is provided on a GUI, wherein each tag must be scanned by a user device having the same unique ID, wherein upon scanning of a required tag, a database is updated to confirm the scan of a given tag, and wherein the GUI identifies the scanning of the scanned tag; wherein upon scanning of all of the tags within a treasure hunt, redirecting the user to a page to bid on an NFT. In a further embodiment, the method wherein the treasure hunt is located in a zoo, and wherein a plurality of tags corresponds to individual animals; upon scanning all of the tags, providing an auction page to bid on an NFT; wherein winning the NFT authorizes a winner to name a baby animal; and wherein the NFT comprises a digital image of the baby animal.

In a further embodiment, the method comprising a rule wherein the rule requires x number of scans at a given event within a geofence; and upon meeting the threshold, making an auction available to all users who scanned a tag.

In a further embodiment, the method wherein x number of users have to purchase the NFT, wherein the purchase is held in escrow until x number of users have purchased the NFT.

In a further embodiment, the method wherein sequential NFTs are awarded, wherein a price is dynamic. In a further embodiment, the method wherein the NFTs are sold when x number of users agree to buy the NFT, and wherein the price of the NFT drops every 10 minutes.

In a further embodiment, the method wherein the purchase is related to an NFT from an arts event.

In a further embodiment, the method wherein the purchase is related to the occurrence of an event occurring at a venue.

In a further embodiment, the method wherein the right to purchase is further defined by a lottery, wherein winning of said lottery enables the authorization to purchase the NFT.

In a further embodiment, the method further comprising a rule requiring a predetermined number of tags to be scanned by said user device; wherein each of said tags comprises a unique tag ID.

In a further embodiment, the method wherein the predetermined number of tags comprises at least three tags. In a further embodiment, the method wherein each of the at least three tags are positioned in the same or a different geofence.

In a further embodiment, the method wherein the tag is provided on a video broadcast of an event. In a further embodiment, the method wherein the tag is provided on a social media platform.

In a preferred embodiment, a method of authorizing a right to purchase an NFT comprising: (a) scanning, via a user device, a tag, said tag comprising a tag ID; (b) defining, within both the user device and a database, a unique ID wherein said database populates information related to said user device; and (c) determining a rule and upon meeting the rule making available the right to purchase said NFT.

In a further embodiment, the method further comprising verifying a seat; wherein said tag ID comprises a known location; and verifying the presence of a record confirming rights to sit in the known location. In a further embodiment, the method further comprising verifying a geolocation wherein upon scanning the tag ID by the user device, determining whether the user device is present within the geolocation. In a further embodiment, the method further comprising counting, via a counting mechanism, the total number of users online at a time t, wherein the rule determines that when x number of users are online at the time t, the right to purchase the NFT is authorized for all users.

In a further embodiment, the method wherein the rule requires the user device to scan at least x number of tags having unique tag IDs.

### BRIEF DESCRIPTION OF THE FIGURES

FIG. 1 depicts an embodiment of a system for user device generated interactions with a system and platform for accessing and viewing targets, such purchasing or minting NFTs.

FIG. 2 depicts a stadium comprising a plurality of seats, rows and sections, and a user device that is accessing a user portal including an option for purchasing, minting, or otherwise acquiring an NFT.

FIG. 3 depicts an embodiment of a system for accessing target information from a user device from within a venue or outside of a venue and various back-end platforms for implementing certain target information or for delivering content to the user device.

FIG. 4 depicts an embodiment of a system for identifying and using information particular to a user device and/or to a tag for directing the user device to an appropriate target.

FIG. 5 depicts an embodiment of a system wherein the system is enabled to push or pull data or information or due to triggering events or rules to modify or augment a target delivered to a user device.

FIG. 6 depicts a flow diagram of an embodiment to confirm the right to purchase and to purchase an NFT according to the system.

FIG. 7 details an embodiment of a geofence and implications for certain rights into interaction with an NFT.

FIG. 8 details a flow diagram of confirming a geolocation within a system of the present embodiment.

FIG. 9 depicts a flow diagram for use of an embodiment of the system using a multilevel approach toward confirming ownership and rights to a seat.

FIG. 10 depicts a flow diagram of an embodiment of the system for engaging with or purchasing an NFT by scanning a digital tag.

FIG. 11 depicts a flow diagram related to purchasing an NFT through the system.

### DETAILED DESCRIPTION OF THE INVENTION

Various embodiments are described more fully hereinafter with reference to the accompanying drawings, which form a part hereof, and which show, by way of illustration, specific exemplary embodiments by which the innovations may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, devices, or any similar or equivalent arrangements known to those skilled in the art. Accordingly, the various embodiments may take the form of an entirely hardware embodiment, an entirely software embodiment or an embodiment combining software and hardware aspects. The following detailed description is, therefore, not to be taken in a limiting sense.

As used herein, the below terms will have the following meanings as may be supplemented elsewhere in this specification:

As used in this application, the words “a,” “an,” and “one” are defined to include one or more of the referenced items unless specifically stated otherwise. The terms “approximately” and “about” are defined to mean ±10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

ADDRESS: Code used to direct a user device, browser, Web app, progressive Web app, administrator device, server, database, API, tool, software, etc., to a resource within the system or a network. Non-limiting examples of addresses include a uniform resource identifier (URI) or a uniform resource locator (URL).

ADMINISTRATOR: The individual or group of individuals with the ability to control and set rules and parameters within the system. This could be a third-party administrator, the proprietor, the venue, the owner of the tags, the team or performer participating in the event, a designated employee of any of the foregoing, etc.

ADMINISTRATOR DEVICE: Any type of mobile or non-mobile processing device such as a desktop computer, handheld computer (e.g., phone, smartphone, tablet, personal digital assistant), wearable computer (e.g., smart watch, smart glasses), portable computers (e.g., laptop, netbooks, Chromebook), or wearable or implantable device, and the like using wireless communication, a camera or other connectivity element that is accessible only to an administrator or proprietor or an employee designated by the administrator or proprietor.

ANALYTICS OR ANALYTICAL DATA: Data collected by the system or retrieved by the system via an API call to an external server or database. Non-limiting examples of analytical data include date, time, GPS location, personal identifying information, etc.

APPLICATION PROGRAMMING INTERFACE (“API”): An application programing interface or programming code that enables data transmission within the system, between the system's server and an external server or between one software product and another. Non-limiting examples of API connections to the system may be third-party vendor databases such as ticketing sales platforms, e-commerce sites such as merchandise sales, social media sites, or any other third-party software product that makes their API available for use by others.

API CALL—Computer code used by the system software to access data, server software or other applications within the system or external to the system, acting as an intermediary between any two devices or servers that want to connect with each other for a specified task. As used herein, API can mean (i) representational state transfer or Rest (RESTful) API; (ii) Simple Object Access Protocol (“SOAP”) API; (iii) extensible markup language — Remote Procedure Calls (“XML-RPC”); (iv) JSON Remote Procedure Calls (“JSON-RPC), (v) open API; (vi) partner API; (viii) internal or private API; (ix) composite API; or (x) any other API that is generally known, or will be come to be known in the art. Thus, the system frequently uses an API, or sends an API request, to an internal or external program, server or database to deliver requested information.

BLOCKCHAIN: Any digitally distributed, decentralized, public or private ledger that exists across a network such as those offered by the providers including but not limited to Etherium, Binance Smart Chain, Polkadot, Flow by Dapper Labs, EOS, Tron, Tezos, WAX, Theta, etc.

BROWSER APPLICATION: An application that runs within the Web browser of a User Device or Computer. The instructions or executable code, typically written in a combination of HTML and JavaScript, is embedded within the Web page that is downloaded from a Web site.

COMPUTER: May be any type of computer such as a laptop computer, desktop computer, tablet, and the like, and includes the appropriate hardware, firmware, and software to enable the computer to function as intended.

CONTENT: Any type of information, images, videos, etc. Non-limiting examples of content can be a video file, an image file, text, executable code, a digital offer, a digital coupon, a digital wallet offer, an AR, VR or mixed reality filter, a game, a poll, an app, an NFT, etc. Content can be specifically formatted for optimal viewing on a user device.

CRYPTO CURRENCY: Any digital currency in which transactions are verified and records maintained on a distributed ledger such as blockchain, for example, Bitcoin, Ethereum, Cardano, Binance Coin, Tether, Solana, XRP, Dodgecoin, etc.

DATABASE MANAGEMENT SYSTEM: A software package designed to define, manipulate, retrieve and manage data in a database, or any other generally accepted definition known to those skilled in the art.

DIGITAL OFFER: Any incentive or reward, for example an incentive to purchase at a discounted price or a free giveaway, offered by a proprietor and delivered to users from a server to a user device through a variety of channels. A Digital offer can be code stored in the user's digital wallet, a MRC displayed in Web browser and presented to a proprietor for redemption, an e-mail with a unique redemption code, a text message, SMS/MMS, push notification or socket notification with a unique redemption code. Digital offers can be stored anywhere on a user device or can be downloaded or turned into physical offers by printing. Digital offers can be limited to a particular user, or a user may share the digital offer to other users. If a digital offer is shared, the same offer can be shared to multiple other users, or the digital offer can be modified by the system when it is shared. Digital offers can also be associated with a unique code that is stored in a database on a server internal or external to the system.

DIGITAL WALLET: A software-based system that securely stores users' information such as payment information, passwords, digital certificates, digital coupons, crypto currency, tokens, NFTs, digital ID such as a digital driver's license or passport, etc. A digital wallet can be a blockchain or crypto currency wallet. A digital wallet can be stored locally on any user device or can be cloud based and accessed by a user device. Digital wallet can also mean digital storage in general on any user device or computer. Digital wallet can also be referred to as a mobile wallet.

DISTRIBUTED DATABASE SYSTEM: Any database that consists of two or more files located in different sites either on the same network or on entirely different networks.

DISTRIBUTED LEDGER: Any database that is consensually shared and synchronized across multiple sites, institutions, or geographies, accessible by multiple people.

DATA SERVER OR SERVER: Any form of electronic device or plurality of devices having at least one computer processor, e.g., a central processing unit (CPU), and some form of computer memory having a capability to store data, as is well known in the art. The server may comprise hardware, software, and firmware for receiving, storing, and/or processing data as described below. The hardware may be in a single unit, or operably connected via a network. For example, a computer or server may comprise any of a wide range of digital electronic devices, including, but not limited to, a server, a desktop computer, a laptop, a smart phone, a tablet, a smart watch, smart glasses, a wearable device or an implantable device or any form of electronic device capable of functioning as described herein.

DYNAMIC ELEMENT: An element that is updated, altered, customized, etc., in response to a change in the status of a metric, trigger, or any other datapoint as determined by the system. A non-limiting example of a dynamic element is the score of a game. If a goal is completed, then the score is updated to reflect this change.

EVENT: Non-limiting examples of an event include a professional, amateur or intermural sporting events (i.e., football, baseball, hockey, basketball, soccer, rugby or cricket game, tennis or golf match, track and field or figure skating event or automobile race), a theatrical performance (play, musical or opera), a musical concert, elementary school, middle school, high school, college or university event, a service or ceremony (i.e., religious or worship), a tradeshow or conference, guided or self-guided tours (museums, galleries and historical site), time spent in a venue such as a visit to a zoo or amusement park, etc.

FAN PORTAL: A GUI, such as a homepage, displayed in the browser of a user device that provides links or access to other pages/modules via buttons or other means of selecting options from a menu of choices. The fan portal can also be used for viewing content and receiving digital offers.

INTERFACE SERVER: Within the system, a program, executable code or API stored on a physical server, cloud storage system or in a serverless environment such as Amazon Web Services, which is capable of communicating with other servers, databases and API's internal or external to the system. The interface server is able to make and receive calls, request and receive data, or execute other functions within systems. The interface server is also capable of running AI and/or utilizing machine learning.

GEOFENCE: A virtual perimeter for a real-world geographic area or an area in or around a venue.

GUI OR GRAPHICAL USER INTERFACE: A graphical interface to enable interactions between a user and the user's device, such as but not limited to an interface to the Web app.

JUMBO SCREEN: Any display within a venue visible to users attending an event at a venue. The jumbo screen can be one display or multiple displays within the venue that can be controlled by the venue. Jumbo screen may also be known as a jumbotron.

LOCATION: An area whose perimeter or parameters are defined in an abstract way without boundaries that are clearly visible to users or proprietors. Non-limiting examples of a location include a town, city, state, country, region, continent, time zone, or geofenced area.

MACHINE-READABLE CODE (“MRC”): A barcode, a quick response (QR) code, near-field communication (NFC) code, radio-frequency identification (RFID) code, universal product code (UPC), machine-readable graphics (e.g., having a pattern, matrix, or the like) coding, instructions coded on a chip, or combinations thereof. A MRC may be may be included into (i) a tag that is mounted to a surface, (ii) identification badges such as, for example, student identification badges, employment identification badges, concert badges, and the like, (iii) merchandise such as t-shirts, sweatshirts, hats, mugs, glasses, posters, CD's, and the like, (iv) a piece of paper, cardstock, or plastic that is handed to users, (v) a video stream viewed over the internet or network television channel, (vi) an LCD/LED/e ink display device embedded, attached or affixed to a surface.

MANIFEST: A file containing metadata for a group of accompanying files that are part of the system that instruct the user device how to handle the system when it is started.

MINTING: Uniquely publishing a token on the blockchain to make it purchasable, saleable, or tradeable.

NON-FUNGIBLE TOKEN (“NFT”): A non-interchangeable unit of data stored on a digital ledger, such as but not limited to blockchain, that can be purchased, sold, auctioned, and traded. As used herein, NFT includes the contract and subject matter associated with the NFT and can also mean semi-fungible token, or fractional NFT. Non-limiting examples of the smart contracts that could govern a NFT include (i) 1/1 NFTs—known as ERC-721 tokens on Ethereum and Polygon, KIP17 on the Klatyn blockchain; (ii) Semi-fungible NFTs—known as ERC-1155 tokens on Ethereum and Polygon, KIP37 on Klatyn.

NFT MARKETPLACE: A platform where NFTs can be stored, displayed, bought, sold, traded, auctioned and in some cases minted.

PROPRIETOR: Any person or entity who purchases, subscribes to, or otherwise uses the system and/or platform and who is not a user. A Proprietor may or may not have administrative privileges to the system. Non-limiting examples of proprietors include, venue owners, event promotors, teams, performers, theatre troupes, religious organizations, educational institutions (i.e., elementary school, middle school, high school, college, university), restaurants, bars, retail establishments, amusement parks, museums, art galleries, advertisers, media outlets (i.e., network television, cable television, radio, internet broadcasts), hospitals and health care systems, ticketing platforms, airlines, ride share services, etc.

PROPRIETOR PORTAL: An access point for a proprietor to enter the system and/or platform typically displayed in a browser.

RECORD: Information that is stored in an electronic or other intangible medium without limitations on how the data is structured.

REDIRECT/IDENTIFICATION SERVER: The server within the system that makes a determination on if a user and/or user device that has entered the system is unique, by locating the manifest stored on a user device and if a manifest exists, associating the unique ID stored in the manifest on the user device with the database of known unique ID's stored on the redirect/identification server, or for confirming other data based on one or more requests to the redirect/identification server.

REDIRECT URL: An address generated by a server, such as the redirect/identification server or the interface server, in response to an incoming request that points the browser on a user device to a different target.

RESOURCE RECORD: A database record associated with a tag ID.

REQUEST: A message sent by one device to another (e.g., phone to server, server to server, computer to server, server to database, etc.) using an address to send the request. For example, upon selecting from the options available in the Web browser, the selection is coded into a request that the Web browser sends to the server via an address. The request typically provides instructions to the server. Non-limiting examples of a request can be—GET, POST, PUT, DELETE, CONNECT, OPTIONS.

RULE: A set of conditional statements that tells the system how to react to a particular situation. Rules can be preprogramed into the system or can be set or changed by an administrator or proprietor.

SYSTEM: The network, tags, digital seat platform, etc.

TAG: A physical (e.g., tangible) form, a digital (e.g., virtual/intangible) form, or may be combinations of both forms that contains an MRC. Physical versions of tags may be constructed from diverse types of materials. The MRC may be printed, etched, or fabricated onto the tag materials such as paper, glass, plastic, metal, fabric, and the like as a few nonlimiting examples. In the case of tags that contain MRC's that are NFC or RFID, the tags may be adhered to, attached to, embedded in, or fabricated on (or combinations thereof) a natural or manmade material such as metal (e.g., aluminum, stainless steel), wood, polymer (e.g., plastic), film, glass, and combinations thereof. The material may then be incorporated into or affixed (e.g., adhesive or other form of attachment) to an object or location. A tag may be printed on a single or multiple use badge or ticket. Digital tags may include LED/LCD screens or a designated location within a video stream in which the MRC is located.

TAG ID: A unique identifier for the MRC affixed to the tag. The unique identifier can be any combination of letters, numbers, and symbols. The tag ID is stored in a database on a server and is coded with information specific to the location of the tag. For example, the tag ID might generally identify the geographic location of the tag (i.e., the United States, Pennsylvania and/or Philadelphia), the general venue location of the tag (i.e., Fenway Park, Madison Square Garden, Carnegie Hall, The Natural History Museum), the specific location of the tag within the venue (i.e., Section A, Row 1, Seat 10, next to Van Gogh's “Starry Night”), or any combination of information.

TAG URL: A unique address assigned to the MRC on each tag that may optionally include the tag ID.

TARGET: A Web page, file, address, GUI, Web app, progressive Web app, portal, content or digital offer delivered to a user device. Those skilled in the art may also refer to a target as an endpoint.

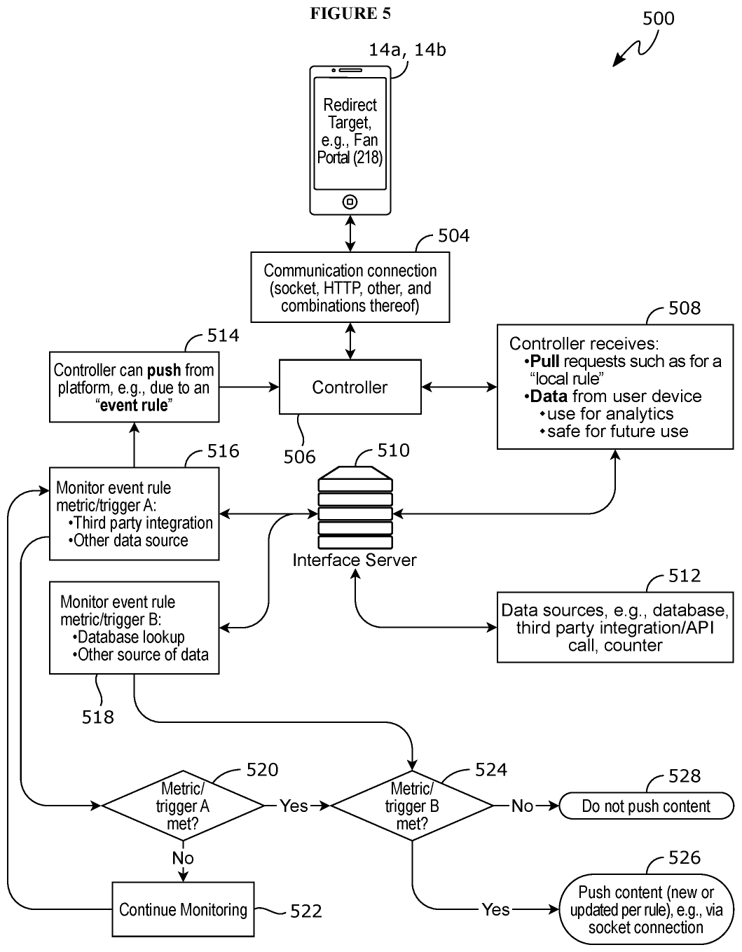

TARGET DETERMINATION PROCESS: The process described in FIG. 5.

TARGET ID: A unique identifier for the Target. The unique identifier can be any combination of letters, numbers and/or symbols that can be stored in a database, on a server, and/or both. The target ID allows the platform to distinguish one target from another.

TICKETING PLATFORM: Both the primary ticketing platform and the secondary ticketing platform.

TRIGGER: The magnitude or condition that must be reached for a certain result to materialize. Triggers can be determined either by the system, an administrator or a proprietor. Non-limiting examples of a trigger can be the start or end of an event, something of significance that occurs during the event (i.e., the 10^{th} goal scored, the first encore by a musical act), a single user completing a certain task, or N-number of users completing a task.

TOKEN: A digital asset that is stored securely on the blockchain, representing a tradeable asset.

TOOLS: Cookies, pixels, widgets, plug-ins, etc.

UNIQUE ID: A unique identifier for the user device. The unique identifier can be any combination of letters, numbers and/or symbols, cookies, digital credentials or it can be a digital certificate such as TLS, SSL, code signing certificate, client certificate, etc. . . . . The unique ID can be stored on the user device in any location on the user device such as the manifest, local storage or digital wallet, in a database on a server, and/or both, and is used to associate the user device with the unique user record stored in a database on a server in the system.

UNIQUE IDENTIFYING INFORMATION: Personal information and demographics collected about a particular user's such as name, address, phone number, e-mail address, credit card information, gender, marital status, academic affiliation (student, faculty, alumni), driver's license number, age, username, password, pin number, social security number, bank account number, salary, etc.

USER DEVICE: Any type of mobile processing device such as a handheld computer (e.g., phone, smartphone, tablet, personal digital assistant), wearable computer (e.g., smart watch, smart glasses), portable computers (e.g., laptop, netbooks, Chromebook), or wearable or implantable device, and the like using wireless communication, a camera or other connectivity element.

VENUE: Any physical location with defined perimeters and parameters such as a stadium, arena, court, track, concert hall, theatre, course, museum, restaurant, place of worship (church, synagogue, temple, mosque, etc.), historical site, cultural site, amusement park, zoo, aquarium, conference center or any other place where events are held or users gather. Venues can also be hotel rooms, cruise ships, trains, airplanes, schools (elementary, middle or high school) or a college campus or dorm.

WEB APP: Executable code that is stored on a remote server and delivered via the system or a network to a browser interface on a user device. The Web app may facilitate communication between the user device and one or more servers such as the redirect/identification server or the interface server.

Historically, proof of purchase, the conveyance of other rights, and similar transactions were recorded on paper. For instance, if you attended a sporting event, a music concert, an artistic performance, or literally anywhere with a controlled entrance, you purchased a ticket, which was printed on paper and either handed to you or mailed to you. After using the ticket to gain entry to the event, you retained a stub portion of the ticket. The stub was your evidence of the limited ownership of your seat or your right to be in attendance in a particular area of a stadium or other venue. After the event, performance, or the like, the ticket stub served as evidence that you attended the event, where you sat at the event, if you had a VIP ticket, and similar information.

Modern ticketing, however, has changed, almost exclusively, to digital transactions. Indeed, most digital tickets have a bar code, some other readable matrix, or even an embedded digital code, and are delivered to a smart phone, or other handheld computing device, so that the digital ticket can be scanned for entry into an event. This digital ticket is then stored or wasted within a user's device, never to again be seen.

Ticket stubs and memorabilia from events, however, can be highly collectible. In some cases, ticket stubs, as one example, have obtained significant historical and collectible value because of the event that occurred such as Woodstock, championship games, games where a world or national record was set or a historical statistic was reached, and similar types of noteworthy events. In the sporting world, championship games include, but are not limited to, a playoff or world series game in baseball, a playoff or Super Bowl in football, a world cup or league match in soccer. Collectables, however, are not limited to significant events; many people collect tickets and other memorabilia from their favorite teams, favorite players, bands, and other similar examples.

Paper tickets are easily tradeable and can be authenticated by numerous third parties to confirm authenticity of the paper ticket, especially for events with valuable tickets or ticket stubs, which could easily be forged. Modern digital tickets, however, have virtually no way to be transferred, sold, or captured within the collectible industry, thus losing a valuable asset for notable events. One of the hallmarks of the present disclosure is that it details how embodiments may confirm or authenticate attendance at an event that took place at a particular time, place, or both, which, in turn, confirms/authenticates the digital ticket, or other type of similar asset associated therewith. Such confirmation/authentication has implications for numerous different use cases.

Embodiments of the present invention described herein enable the ability to acquire a non-fungible token (NFT) through the scan of a tag at the event and/or venue. An NFT, by its nature is a unique, i.e., non-fungible, record that is stored in a distributed ledger commonly referred to as a blockchain. There are numerous blockchain providers that store NFTs, including but not limited to, Etherium, Binance Smart Chain, Polkadot, Flow by Dapper Labs, EOS, Tron, Tezos, WAX, Theta, and more. An NFT does not typically possess inherent value. The value of the NFT, in fact, comes from the subject matter associated with the NFT and rights, if any, granted with respect to that subject matter. For example, NFTs have been associated with artwork, both physical and digital artwork. Digital artwork is created digitally (e.g., on a computer, with a digital camera, etc.,) and saved as a data file, often a jpeg or another type of file. To be associated with an NFT, physical artwork is represented by a data file such as a digital photo of the physical artwork. The data file of the artwork may then be stored in a central server, an interplanetary file system (IPFS), or other storage as is commonly associated with storage of the subject matter associated with NFTs. Thus, the value in owning an NFT is typically gained by its associated subject matter, the appeal and sacristy of that subject matter, and the rights provided by the NFT contract, among other variables.

To associate subject matter with an NFT, creators typically go through a process commonly referred to as minting. Minting generally refers to the actual recording or adding of the NFT to the blockchain, which may occur at the time of subject matter association (e.g., NFT creation) or when the NFT is first sold after creation (e.g., “lazy minting”). To create one or more NFTs for certain subject matter, the creator uses a digital wallet such as a cryptocurrency wallet, which may be a noncustodial wallet, and selects a marketplace, a blockchain provider, or a project (e.g., Web site for subject matter/NFT collections). The cryptocurrency wallet enables payment (e.g., with appropriate crypto/digital currency) for the minting process, listing fees, other fees, and/or NFT purchase after minting. The cryptocurrency used should be accepted by the platform of choice (i.e., marketplace, blockchain provider, project). NFT marketplaces include, without limitation, Open Sea, Mintable, and Rarible. Many platforms enable one-click style minting, wherein the NFT is created by simply uploading subject matter data to the platform, designating a storage option for the data and contract (e.g., IPFS), determining the desired number of NFTs for the subject matter, and clicking the appropriate button. Of course, all the necessary fees must also be paid. In return, the creator/owner may get some sort of proof of NFT ownership (i.e., “proof of ownership”) delivered to one or more digital wallets, such as the cryptocurrency wallet. Thereafter, the creator/owner of the NFT may do what he/she wishes with the NFT, but the rights associated with the subject matter are provided in the NFT contract, which may sometimes be referred to as the “metadata,” and/or smart contract. Rights in subject matter may include sole ownership of the original subject matter that is not-to-be-duplicated, ownership of a copy of the subject matter, or ownership of the NFT itself with no ownership interest in the subject matter, as a few non-limiting examples. The creator of the subject matter and/or NFT may determine what rights (i.e., the NFT contract) in the subject matter, if any, come with NFT ownership at the time the NFT is minted. As detailed herein, an NFT is a digital asset, and more particularly a digital asset for subject matter related to an event, venue, or the like. The NFT may be acquired via scanning the encoded tag while the user is at the event (e.g., tag is on the seatback in front of the user), remotely watching the event (e.g., tag is in/on a television broadcast), or the like. The systems and methods described herein provide an easy, convenient, and accurate way for users to acquire such NFTs and receive confirmation of NFT ownership simply by scanning an encoded tag with a device such as, without limitation, a smartphone. The following paragraphs provide details about various nonlimiting embodiments of the present invention.

Proprietors that house or run venues and/or events, sell tickets, or otherwise provide content may utilize embodiments of the present invention to create NFTs for subject matter relating to the events, venues, and the like. For example, if a user purchased a ticket for seat 1, row 1, section 100 to attend a baseball game, and the baseball game turns out to be a special game because player Smith hits a homerun to win the game, the user may want to memorialize his or her attendance at the game and the seat in which the user was sitting at the time the homerun occurred. Embodiments may enable a user to do so by scanning an encoded tag to acquire an NFT. Proof of NFT ownership may be secured in the user's digital wallet. As another example, a user attends the last concert performed by a rock band's original members. The user desires to acquire an NFT to commemorate the user's presence at the concert. The user may mint (i.e., create) the NFT by scanning an encoded tag at the venue, which may be specifically related to the ticket (e.g., on or with the ticket) or generally related to the ticket as the tag is physically located at the venue. In other embodiments, the proprietor, whether the owner of a venue (e.g., stadium) or a team, or a manager of a group of artists or the artists themselves may mint certain NFTs to be released during the event. The NFTs may be released globally (e.g., to all users) or selectively (e.g., a designated group of users), or upon meeting some threshold or defined limitation that is set by the proprietor. These and other embodiments are explored in greater detail below.

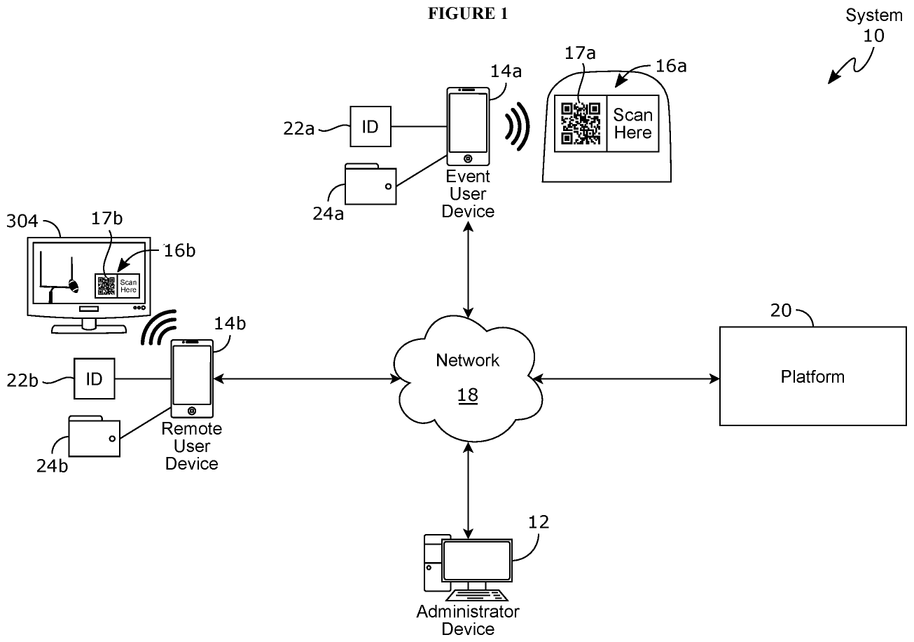

A high-level overview of an exemplary system (10) is shown in FIG. 1. The system (10) may include an administrator device (12), a platform (20), a user device (14a) associated with an event user (e.g., physically at the event/in the venue), a user device (14b) associated with a remote user (e.g., not necessarily at the event/in the venue), a plurality of tags (16a, 16b) and one or more networks (18). Generally, each user device (14a, 14b) may be used to scan, read, or otherwise detect (collectively “scan”) machine-readable code (“MRC”) (17a, 17b) associated with a respective tag (16a, 16b). The act of scanning a tag (16a, 16b)/MRC (17a, 17b) initiates communications between the user device (14a, 14b) that scanned the tag (16a, 16b) and the platform (20), which may result in the rendering of a Web page or the like (e.g., related to the event) by a Web browser and/or other application running on the user device (14a, 14b). Communications between user devices (14a, 14b) and platform (20) is typically via one or more networks (18), which may include, without limitation, the Internet, mobile networks, cloud-based platforms, or combinations thereof.

A proprietor may use a network of encoded tags (16a, 16b) to identify points of interest (e.g., locations, objects, people, etc.). The number of tags (16a, 16b) in the network and placement of tags on, in, or near points of interest is at the discretion of the proprietor to fit its particular assets and needs. Further, a proprietor may add to or subtract from the number of tags (16a, 16b) in the network at will. Thus, the number of tags (16a, 16b) in a proprietor's network may be dynamic, either more or less than an original network of tags. Each tag (16a, 16b) in the network of tags has a unique identifier (tag ID), which may be used to identify a particular point of interest. For example, a tag (16a, 16b) may be situated on or near a seat in a stadium, and the user who purchased a ticket to sit in that seat is the “limited owner” or renter of that seat for a particular event. In certain embodiments, it may be possible to have multiple copies of the same tag, each with the same tag ID, in locations where multiple scans would be desirable at the same time by multiple users. Thus, at the entrance to a stadium, a plurality of tags could be located at different entrance points, each having the same tag ID.

As is implied in FIG. 1, a certain number of tags (16a) may be present at the venue (“in-venue tag”), and additional one or more tags (16b) may be remote from the venue (“remote tag”) where the MRC (17b) is displayed in/on a video transmission, signal, or the like, or on a Web page associated with the event, venue, and/or television network, as a few non-limiting examples. Of course, there is the possibility that a user at the event/in the venue scans the remote tag (16b) with his/her user device (14a). Each user device (14a, 14b) may also include, or may eventually include, a unique identifier (22a, 22b) to uniquely identify the user device (14a, 14b) and a digital wallet (24a, 24b) to securely store a digital record, which may comprise sensitive information such as a driver's licenses, account information (e.g., banks, crypto currencies, credit cards), titles, tokens, tickets, vouchers, coupons, tickets, ticket records, ticket locators and the like. The wallet can or storage can also store a digital file (301a, 301b), which is typically an image or other data file that is not related to personally identifiable information, and said digital file may be stored, whether within the digital wallet or on the user device. The digital record, may be a record stored within a database on a server that contains the unique ID and unique identifying information associated with that unique ID for each user that accesses the system. The user/device record can contain an unlimited amount of information about the user device and presumably the user who owns the user device such as, but not limited to a history of events attended, digital offers used, gambling wagers made, NFTs minted or purchased, venues or locations visited, concession or merchandise purchases, donations made, incident reports, tags scanned, other actions taken, etc. This may further include certain information related to demographics, event attendance history, purchasing history)as well as information about the user device (type of device, GPS location of the device when is scans an MRC).

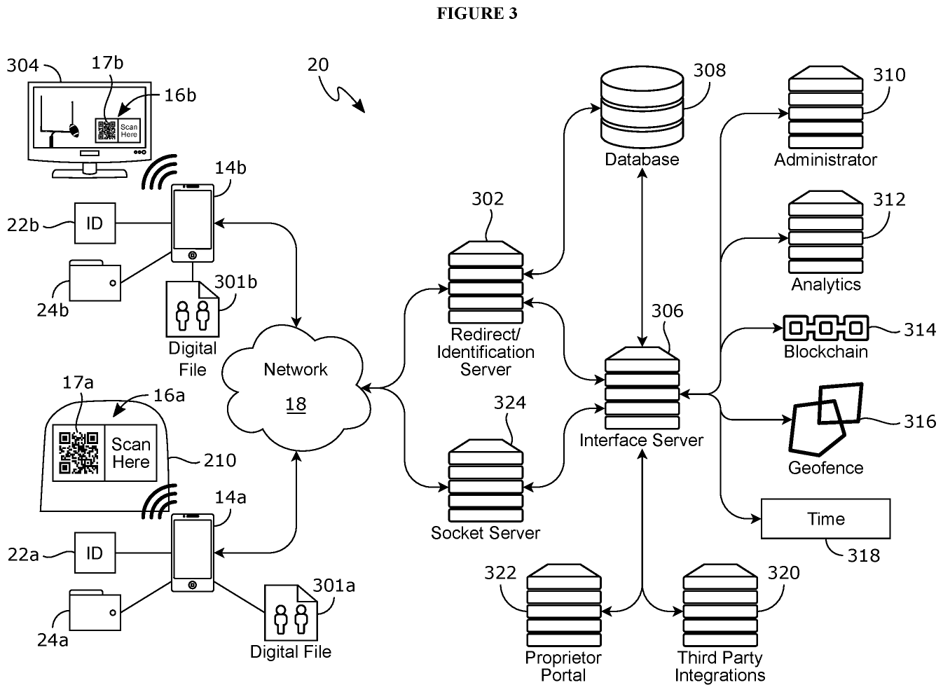

The proprietor may also access platform (20), albeit via the administrator device (12) and one or more networks (18). The administrative device may be located at the venue, or it may be at a location remote from the venue. Generally, the proprietor may access a proprietor portal (FIG. 3 at [322]) hosted by platform (20) to perform administrative and/or other activities such as determining what content (or other) will be sent to the user device (14a, 14b) in response to scanning a tag (16a, 16b).

In addition to hosting the proprietor portal, platform (20) may host a variety of other services including, without limitation, event user and remote user access to content associated with the event, venue, proprietor, and the like. As such, platform (20) may include, or may include access to, one or more servers, databases, application programming interfaces (APIs), artificial intelligence/machine learning algorithms, other algorithms, code, blockchains, blockchain platforms, geofences, third-party integrations, times stamp, and more, which is detailed below, with reference to accompanying figures.

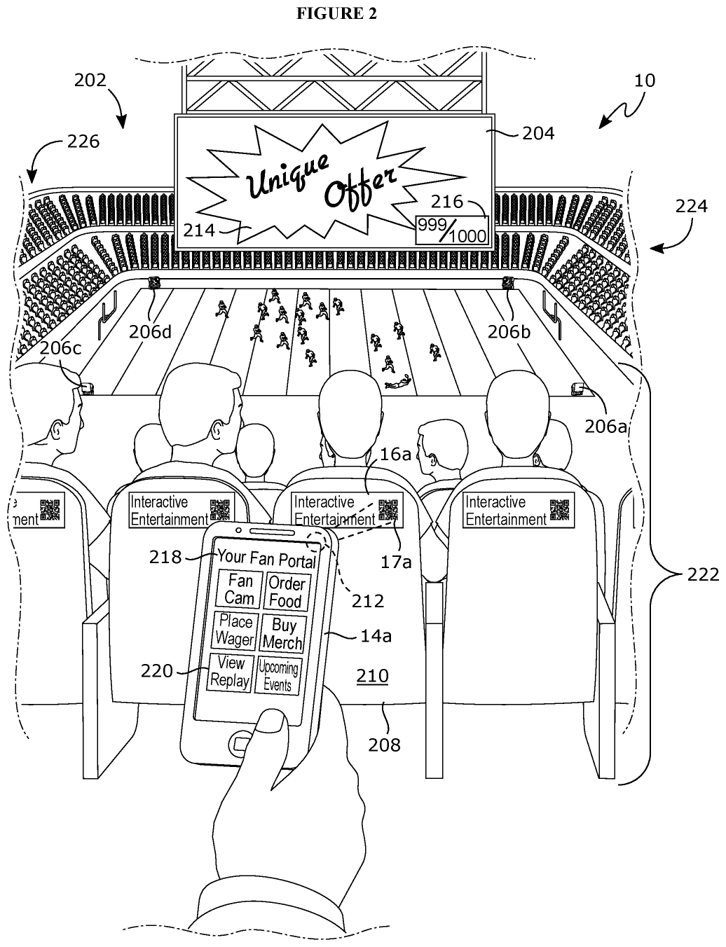

FIG. 2 shows an exemplary venue (202), which includes a portion of system (10) shown in FIG. 1. In this case, the venue (202) is a football stadium including a jumbo screen (204), recording devices (206a, 206b, 206c, 206d), seats (208), and a plurality of tags such as tag (16a). Although a stadium is shown, the venue (202) can be any venue: small, large, indoor, outdoor, permanent, temporary, one structure, several structures, an entire city, and variations thereof. Thus, a venue (202) can be any area or space occupied by or intended for something, and as such associated amenities and accoutrements may drastically vary from venue to venue. In this example, the stadium has jumbo screen (204), which may display a wide variety of video content as is customary for a football game, though such display screen is not necessary for functionality of the system. The stadium also includes optional recording devices (206a, 206b, 206c, 206d) such as video cameras for recording the football game and other activity, which is also customary for this type of venue (202). Likewise, an event may be any event including sporting events, artistic performances, trade shows, conferences, ceremonies, services, self-guided tours (e.g., at museums, historic sites), and zoos as a few non-limiting examples. Notably, museums, historic sites, zoos, and similar examples may be both the venue and the event or house the event.

In the example of FIG. 2, each seat (208) has a seatback (210) with a tag (e.g., 16a) disposed thereon. In this way, event users can easily see a tag (e.g., 16a) directly in front of them while they are sitting in their seats (208). Thus, the tag (e.g., 16a) that the event user sees is associated with the seat (208) in which the user is sitting. Tag association with a particular seat (208) is desirable in embodiments that take advantage of knowing the event user's seat location such as for food or merchandise delivery directly to the seat (208), as non-limiting examples. In-venue tags (e.g., 16a), however, are not limited to being positioned on seatbacks (210); they may be placed in a wide variety of locations within a venue (202). For example, if in-venue tags (16a) are associated with particular seats (208), they may be placed in any other location on or near the associated seat (208) such as an arm rest, a cup holder, on the seat (208) next to the event user's leg, on the ground, or on a structure near the seat (208) such as a wall, a pillar, or the like. It should be noted that in-venue tags (16a) may be associated with other locations/points of interest, and thus may be placed at or near the locations/points of interest such as entrances, levels, sections, isles, loge seats, individual people (e.g., with a tagged badge, tagged ticket, or the like), restrooms, various additional possibilities, or combinations thereof. Therefore, while one example of in-venue tag (16a) placement is illustrated in FIG. 2, in-venue tag (16a) placement should be broadly construed to include any placement suitable for use as described herein. Tags (16a) may be associated with one or more groupings, for example, by a section, (222, 224, or 226), wherein grouping of tags (16a) may provide certain benefits in the various embodiments detailed herein. Alternative placement schemes that may be devised by one skilled in the art, consistent with the teachings of the present invention, should be considered within the scope of the present disclosure.

As was mentioned with respect to FIG. 1, each tag (16a, 16b) in the system (10) has a machine-readable code (17a, 17b) associated therewith. The term machine-readable code (“MRC”) as used herein should be broadly construed to include “graphics” type codes such as quick response (QR) codes, universal product code (UPC), snapcodes, and/or any other type of machine-readable graphics (e.g., having a pattern, matrix, or the like) coding known in the art or later developed. Importantly, as used herein, the term machine-readable code/MRC should also be construed to include “chip” technologies that store data on a chip such as, without limitation, near-field communication (NFC) and radio-frequency identification (RFID) technologies, as is known in the art or is later developed. Thus, MRC can be read, scanned, detected or otherwise decoded (collectively, “scanned”) by an appropriately enabled (e.g., camera, QR scanner, and/or NFC reader [212]) user device (14a, 14b).

In-venue tags (16a) may be physical (e.g., tangible), digital (e.g., virtual/intangible), or combinations of both forms. Physical tags may be constructed from diverse types of materials. In the case of tags having one or more graphical/matrix type codes such as QR codes, barcodes, and the like, the code may be printed, etched, fabricated, or the like on materials such as paper, glass, plastic, metal, fabric, and the like, as a few nonlimiting examples. In the case of NFC/RFID enabled tags, chips/antennae may be adhered to, attached to, embedded in, or fabricated on (or combinations thereof) a natural or manufactured material such as metal (e.g., aluminum, stainless steel), semiconductor, wood, polymer (e.g., plastic), film, glass, and combinations thereof, without limitation. The material may be incorporated into or affixed (e.g., adhesive, or other form of attachment) where desired. Digital tags may be displayed on a screen or communicated via radio waves. In the case of QR codes, barcodes, and the like, the graphical code may be displayed on a display screen such as the jumbo screen (204) or a display screen associated with the event user's seat (208), other locations/point of interest, or combinations thereof. Thus, the in-venue tag (16a) may be a video display, such as LCD, LED, e-ink, or other visual display and/or text accompanying the MRC (17a). In fact, most, if not all, remote tags (16b) will be a display screen such as on a television screen, computer screen, appliance screen, and the like, having the MRC (e.g., 17b) displayed thereon, or text on the display screen identifying the MRC (17b), although embodiments are not limited thereto.

Information encoded on or in each tag in the system (10) may include an address to direct a request (e.g., for a Web page) from the user device (14a, 14b) to a server or the like on the network (18) such as a server on platform (20). The address may be in the form of a uniform resource identifier (URI) such as a uniform resource locator (URL), according to a non-limiting embodiment. In this way, when the user scans the tag (16a, 16b) with the user device (14a, 14b), the user device (14a, 14b) sends a request to the appropriate network (18) location. In the example shown in FIG. 3, when the event user uses his/her user device (14a) to scan tag (16a), the event user device (14a) obtains an address from the MRC (17a) associated with the scanned tag (16a) and sends a request via the network (18) to the address destination. As one example, the address is a URL that causes the event user device (14a) to send a request to a redirect/identification server (302), on platform (20), which receives the request. Similarly, when the remote user uses his/her user device (14b) to scan the MRC (17b) on a screen (304), a similar URL is obtained which causes the request from the remote user device (14b) to be sent to the redirect/identification server (302), which receives the request.

In a typical embodiment, each tag (16a, 16b) in the plurality has a unique tag identification number (i.e., “tag ID”), which may be appended to the URI/URL, although embodiments are not so limited. The tag ID may be used by the platform (20) for several reasons, one of which is to identify a point of interest/location associated with the tag (14a, 14b) via a tag ID lookup. For example, when a request comes from the event user device (14a), the platform (20) knows that the request came from within the venue (202) and is associated with the seat (208) in which the event user is sitting. And when the request comes from the remote user device (14b), the platform (20) knows that the request is in response to scanning a tag (e.g., 16b/MRC 17b) in transmission, on a Web page, or the like, and the platform (20) knows which transmission/Web page is associated with the scanned tag (16b). In an embodiment, the tag ID may be appended to the URL (or URI) such as by one or more parameters, pattern matching techniques, or other such mechanism for encoding information in a URI, URL and/or browser request.

FIG. 3 details an exemplary infrastructure that may be used by platform (20) although infrastructures are not limited thereto. This infrastructure may include the redirect/identification server (302), an interface server (306), a database (308), an administration server (310), an analytics server (312), a blockchain, access to a blockchain, or both (314), a geofence (316) a timestamp (318), one or more third-party integrations (320), the proprietor portal (322), and a socket server (324). Generally, user device (14a, 14b) communicates with the platform (20) via redirect/identification server (302) as was previously described. Redirect/identification server (302), accept requests from user devices (14a, 14b), sends responses to user devices (14a, 14b), and performs various other methods as described herein. As one non-limiting example, the redirect/identification server (302) may forward information (e.g., URLs, parameters, etc.,) from user device (14a, 14b) requests to the interface server (306). The interface server (306) manages most, if not all the tasks involved with processing requests, such as handing off/directing tasks, functions, calls, and the like where needed. The interface server (306) may also return request responses to the redirect/identification server (302). If a request came from a user device (14a or 14b), then the redirect/identification server (302) forwards the response to the requesting user device (14a or 14b). Examples of tasks, functions, calls, and the like that the interface server (306) may hand off include, without limitation, database (308)/blockchain storage, lookups, etc., administrative and back-end tasks/functions to the administration server (310), analytical tasks/functions to the analytics server (312), geolocation tasks/functions (316), time/timestamps (318), API calls to third-party servers for third-party integrations (320) and establishing socket connections via socket server (324).

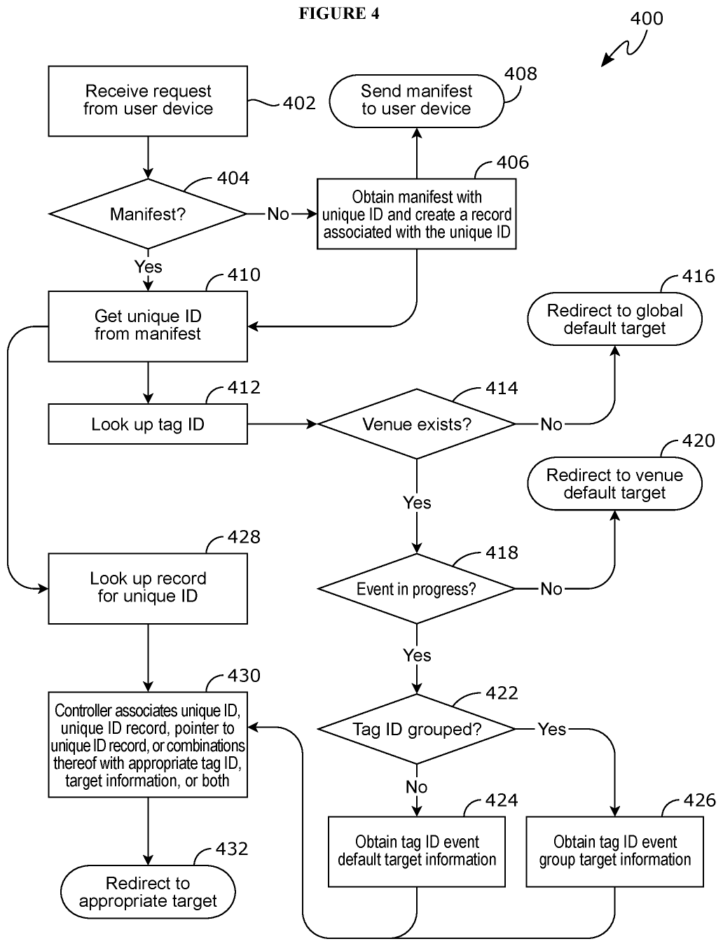

Referring to FIGS. 3 and 4 together and using the request from event user device (16a) as an example, a method (400) may begin with the redirect/identification server (302) receiving the request (step 402) from the event user device (14a). From there, the redirect/identification server (302) may check to see if the event user device (14a) has a manifest (containing the unique ID, or just the unique ID alone) loaded thereon (step 404). If no, the redirect/identification server (302) may obtain a manifest and assign a unique ID (e.g., from database [308]) for the event user device (14a, step 406). The manifest includes a unique ID to identify the event user device (14a) with an identifier that is not shared with any other user device (e.g., 14b). The redirect/identification server (302) will also cause the unique ID for the event user device (14a) to be stored in a database such, as database (308), as is appropriate for the database management system (step 406). The user device may further comprise a digital file (301a, 301b), which may be related to or used in minting an NFT. As used herein, the term “record” refers to information that is stored in an electronic or other intangible medium without limitations on how the data is structured. A record may include and/or point to related data. For example, a unique ID record for a unique ID may include the unique ID and any other data related thereto, which may be stored in database (308) or other appropriate data storage. After obtaining the manifest and/or the unique ID, the redirect/identification server (302) may then send the manifest together with the unique ID to the event user device (14a, step 408), which may be maintained on the event user device (14a) in a digital wallet, other secure repository, or both. At step (410), the redirect/identification server (302) may maintain a copy of the unique ID for further use in the method (400), other methods described herein, or both. If the event user device (14a) already has a manifest (step 404, yes), the redirect/identification server (302) obtains the unique ID from the manifest (step 410). In an embodiment, the redirect/identification server (302) may also obtain data such as current time, date, location, etc. from the event user device (14a), manifest, request, or combinations thereof at step (410).

In an embodiment, the redirect/identification server (302) may pass information needed to further method (400). For example, the tag ID may be passed to the interface server (306) for a tag ID lookup (step 412), such as in database (308), the administration server (310) and/or any other suitable database or server. In this instance, the redirect/identification server (302) obtained the tag ID from the request made by the event user device (14a). In an embodiment, the tag ID is appended to the URL, and thus the entire URL, or a portion thereof, may be passed to the interface server (306) for use in looking up the tag ID. Looking up the tag ID provides information about the venue (202) and/or event. To clarify, when a particular venue (202) installs tags (16a) and/or uses tags (16b), the tag IDs for the installed/used tags (16a, 16b) are associated with the point/location of interest and the particular venue (202). Thus, if a tag is installed proximate seat 1, row A, section 100, database (308) information associates the installed tag's (16a) tag ID and that particular seat (208), which is in that particular venue (202). Since the tag ID is known to belong to a particular venue (202), the interface server (306), the administration server (310) via the interface server (306), any other suitable server, or combinations thereof makes a series of determinations using the tag ID, which was received in response to a request from a user device (14a, 14b) prompted by scanning the tag (16a, 16b). One determination is if the venue (202) is actively implementing platform (20) services (step 414). For example, the venue (202) may have tags (16a) installed but it is no longer using the tags (16a), or it is not using the tags for a particular event. If not, the event user device (14a) is redirected to a global default target (step 416) that may inform the event user that the services are no longer available, are temporarily out of service, or the like. If the venue (202) is actively implementing platform (20) services, the method (400) may make another determination. At step (418), the method (400) may determine if a particular event is currently (or soon to be) in progress, or recently ended. In an embodiment, an event may be determined to be in progress based on the time that the event is scheduled to begin. Since many venues (202) open before the actual event begins, and close after the actual event ends, the window set for an event to be in progress may encompass a given amount of time before and after the actual activity begins/ends. In an embodiment, the time that the “event in progress” determination is made (step 418) may be recorded to serve as a timestamp to approximate the time that the event user device (14a) scanned the tag (16a). In other words, the unique ID, tag ID, and time determination may be recorded for later use, in certain embodiments. If the event is not in progress, the event user device (14a) may be redirected to a venue default target (step 420) such as a Web page for the venue, or another Web page such as a page to identify that an incident has occurred at the venue (202) at the location/point of interest in which the tag (16a) was scanned. Incidents may encompass any sort of incident such as a need for something to be cleaned up to calling emergency services.

If the event is in progress, the method (400) may also determine if the tag ID belongs to a grouping of tag IDs (step 422). Tags (16a, 16b) may be grouped for many reasons and in many different ways. Tags (16a, 16b) may also belong to more than one group. As one non-limiting example, in the stadium of FIG. 2, the tags (16a) may be grouped by seating type or section (e.g., FIG. 2, 222, 224, or 226), e.g., VIP seats may belong to one group, loge seats to another group, and discount/student seats may belong to yet another group. If data associated with the tag ID indicates that the tag belongs to a group, the event user device (14a) may be redirected to a target for the particular group. For instance, the target for users sitting in VIP or loge seats may be a Web page associated with event that includes premium content, offers, and the like, whereas the target for users sitting in discount/student seats may be a Web page having content and features that typically appeal to students, recent graduates, or the like. Thus, the method (400) obtains the information it needs to enable redirection to the appropriate group target (step 426). If data associated with the tag ID indicates that the tag does not belong to a specific group, the event user device (14a) may be redirected to an event default target such as a standard Web page for the event. Thus, the method (400) obtains the information it needs to enable the redirection (step 424) to the default target for the event. In an embodiment, the information needed for redirection may include a URL for the target with parameters, values, patterns, or the like appended thereto such as a target ID to identify the target and the tag ID.

Method (400) may simultaneously process other data such as looking up one or more records associated with the unique ID (step 428). In embodiments, the platform (20) may gather information relating to user activities via the user device and unique ID. For example, the platform (20) may gather data relating to tags that the user has scanned in the past (across a variety of different events, venues, or the like) and activities associated with those tag scans (e.g., purchases made, content looked at, coupons downloaded), although embodiments are not limited thereto. This data may be stored in association with the unique ID assigned to the event user device (14a). Thereafter, a controller may associate the unique ID, its record, its record location or the like with the tag ID, target ID, a URL, any other determined information, or combinations thereof (step 430). The event user device (14a) may then be redirected to the appropriate target that has been determined for the event user device (14a).

When a request comes from a remote user device (14b), the method (400) starts out essentially the same as with the event user device (14a). That is, the redirect/identification server (302) receives the request (step 402), checks for a manifest containing a unique ID (step 404), assigns a manifest with a unique ID if one has not yet been assigned (step 406), and sends it to the remote user device (14b, step 408) for secure storage thereon. If the remote user device (14b) has a manifest, then the redirect/identification server (302) obtains it (and other information such as a unique ID) from the remote user device (14b). Either way, the redirect/identification server (302) has the information that it needs such as unique ID, URL, tag ID, and the like, and forwards the information to the interface server (306) to continue the method (400). The interface server (306) may then look up, or cause to look up, the record associated with the unique ID (step 428) assigned to the remote user device (14b). At the same time, the interface server (306) may cause a determination to be as to whether the venue exists (step 414). In this case the interface server (306), or other server, may look at the data associated with the tag ID to determine from where the tag (16b) that was scanned originated.

For example, the MRC (17b) may have originated from a particular signal, transmission, etc., (e.g., network, regional network, etc.), Web site (e.g., for the venue, a streaming service, etc.) or the like. If the method (400) determines that the venue does not exist, for example, if the tag is to an unrelated element, then the remote user device (14b) is redirected to that unrelated element or to a global default target (step 416), for example if the tag is related. Assuming that the venue in this case does exist, the interface server (306)/method (400), then determines whether the event is in progress (step 418). If the signal, transmission, Web page, or the like is transmitting an event as it is occurring in real time then the event is in progress. Such can also be determined by a time stamp or time record set within the system. Either way, in an embodiment, the time the determination is made may be recorded by the platform (20). If the event is not occurring in real time (e.g., the user is watching a recording after the fact), then the remote user device (14b) will be redirected to an appropriate target such as a Web page relating to the event (step 420). However, the proprietor can set any time parameter to define “real time”. For example, a proprietor may desire to allow recordings watched within N number of days of a live event to constitute real time. The interface server (306) may then determine if the tag (16b), via the tag ID belongs to a group (step 422). For instance, different tags (16b) may be associated with different signals, transmissions, Web sites, or the like. Some of these tags (16b) may form groups based on predetermined criteria. Thus, if the tag (16b) belongs to a group, the remote user device (14a) will be redirected to the target for the appropriate group, and if not, the remote user device (14a) will be redirected to the default target. The default target for remote users may or may not be the same default for event users. Either way, the information relating to the determined redirection target is obtained (steps 424, 426). At step (430), a controller may associate the unique ID, the record for the unique ID, a pointer to the record for the unique ID, the tag ID, and target information such as a URL, target ID, or both. Thereafter, the remote user device (14b) is redirected to the appropriate target (step 432), as was described with respect to the event user. In certain embodiments, the step of (428) may be provided in parallel to or concurrent with the lookup of the tag ID (step 412), where the unique ID is necessary for determining any of the other elements. Furthermore, the unique ID may be stored, for example in local memory or cache, which is readily accessible or known to the system after step (410).

In an embodiment, the user device (14a, 14b) may receive a redirect URL from the redirect/identification server (302) at the end of method (400) to redirect the user device (14a, 14b) to the appropriate target. For instance, the method (400) may return a target ID to identify the particular target. The target ID, tag ID, unique ID (and/or information associated therewith), or combinations thereof may be appended to the redirect URL for the target, which is sent to the requesting user device (14a, 14b). The requesting user device (14a, 14b) then uses the redirect URL to send a new request, this time for the target, which is received by the redirect/identification server (302) and is forwarded to the interface server (306) for processing. Alternatively, the target ID, tag ID, and unique ID may be used by the platform (20) without sending a redirect URL to the requesting device at the end of method (400). Regardless of the forgoing, the requesting user device (14a and/or 14b) receives the target of the redirection whatever that target may be. For example, a target may be a static Web page, a dynamic Web page, an application delivered by way of one or more Web pages, files, data, information, or combinations thereof. As one non-limiting example, the fan portal (218) may have been the target identified by the target ID, and it may include application code “wrapped” or embedded in in an HTML document, and wherein such fan portal (218) may be used to access and purchase NFT. Application code includes, but is not limited to, Web application code, progressive Web application code, cloud-based application code, native application code, native mobile application code, other such code, or combinations thereof. The HTML document (and cascading style sheet, etc.) generally determines the format/layout of what the user sees as is known in the art.

Furthermore, targets are not necessarily static. In fact, the same tag (e.g., 16a) may cause a user device (e.g., 14a) to be redirected to distinct targets depending upon when the particular tag (16a) is scanned. For example, a venue (202) hosts many events over the course of a season, year, decade, etc. Each event may have its own target as the individual events are distinct. For example, the fan portal (218) may be the target of a game in progress, such as the football game shown in FIG. 2. The game in progress is between team A and team B. The next game (or other event) hosted at the venue (202) may be a soccer game; thus, the fan portal (218) for the soccer game is different from the fan portal (218) for the football game. In other words, the two fan portals (218) are distinct targets for redirection. The target that is reached by scanning the tag (16a) is coordinated with targets, such as via a distinct target ID, so that the user device (14a) is redirected to the football fan portal (218) during the football game and the same user device (14a) can be redirected to the soccer fan portal (218) during the soccer game even though the exact same tag (16a) is scanned by the exact same user device (14a). Of course, this is one non-limiting example. A single tag (16a) may be used by a proprietor to redirect a user device (14a, 14b) to any desired target. Thus, the target to which the user device (14a) is redirected may be changed from game-to-game.

A proprietor may also change a target during the course of a particular event. For example, referring again to the fan portal (218) shown in FIG. 2, the user may use the fan portal (218) to partake in activities such as buying food or merchandise, placing a wager, view replays, etc. However, at any time during the event, the jumbo screen (204) may display a hidden “unique offer” (214) that is only available to the first 1,000 users who respond to the “unique offer” (214) after it is displayed on the jumbo screen (204) by scanning a tag (16a) or the like. A countdown (216) on the jumbo screen (204) shows the number of event user devices (14a) that have claimed the “unique offer” (214). When the threshold number (1,000) is reached, the unique offer may be revealed and is no longer available to any other users. One way an event user may respond to the hidden “unique offer” (214) is by scanning or rescanning the tag (16a) while the unique offer (214) is available. In this case, the user device (14a) may be redirected to a Web page or the like, for the unique offer (214), e.g., to input information, make payment, or the like, per a process that is the same as/similar to the method (400). The redirect target of this scan, however, is the “unique offer” (214), which may offer the right and ability to purchase an NFT, and not the fan portal (218). Another way a user may be able to respond to the “unique offer” (214) is by a pop-up window (e.g., in/over the fan portal [218]) or the like, which may be pushed via the socket server (324) in a non-limiting embodiment. Thus, the term “target” should be broadly construed although it may be described herein with respect to obtaining a fan portal (218) or other specific examples. One of ordinary skill in the art would understand a target of redirection as described herein may be a multitude of different targets with various purposes, designs, capabilities, and the like. Therefore, the target to which a particular tag (16a, 16b) is assigned, may be changed by simply changing the target identifier (“target ID”) associated therewith.

There may be instances where the content delivered via the target may need to be changed, updated, altered, released, opened, or other such stipulations based on a rule and/or other conditions. Rules may be defined to force a modification of content already delivered, deliver additional content, information, data, release content, and/or make other such changes as would be appreciated by one skilled in the art. In this non-limiting example, the target delivered at (432) FIG. 4 includes a Web application, such as a progressive Web application (PWA), that has a pull function, which may be rule-based. The pull function, as one non-limiting example, may be time based, requesting information to be pulled from the platform (20) via the interface server (306) every 10 seconds, minutes, N seconds, N minutes or the like. As another non-limiting example, the pull function has the ability to have data updated on a rolling basis. In the sporting world, this is common when updates are provided to the score of a game, the time left in a game, or both as non-limiting examples. The platform (20), however, may push rolling data to a user device (14a, 14b) instead of having it pulled from the platform. Pushed data may be sent to user devices (e.g., 14a, 14b) without being requested. Data may be pushed to a user device (14a, 14b) for any number of reasons, a few of which are detailed herein. Thus, information, data, etc., may be pushed to a user device (14a, 14b), pulled for a user device (14a, 14b,) or both. In many instances, a Web application or the like may be based on a template having dynamic elements embedded therein. The contents of such dynamic elements may be altered via push techniques, pull techniques, or both. Content, data, information, and the like, may be pushed and/or pulled via a socket connect utilizing a socket server (324) or any other socket connection, communication connection, protocol, or combinations thereof as is available to the platform (20) under a set of given circumstances.

The method detailed in FIG. 5 may be invoked while the target of redirection (e.g., fan portal [218]) is loading on the requesting user device (e.g., 14a and/or 14b), after the target is already loaded on the requesting user device (14a and/or 14b), or both. As with all methods detailed herein, steps in the method (500) may be used in whole or in part, in the order shown or a different order, be executed on one device or more than one device, be used in combination with some/all of the other methods described herein or as is known in the art, or combinations thereof.

Using fan portal (218) as a non-limiting example while referring to FIG. 5, oftentimes it may be desired to alter information, regardless of type (e.g., video, images, instructions, etc.,) while the user is using the fan portal (218). Information may be altered using push, pull, and other techniques, taking advantage of the communication connection (504). The communication connection (504), which may be a socket connection or any other appropriate type of connection, allows communications between the user device (14a and/or 14b) and the platform (20) via the one or more networks (18). A controller (at 506) may be a set of software code for managing, directing, or generally being in charge of one or more rules, enabling pushing and/or pulling of information per the rules. In this example, rules may be used to change content on the user device (14a and/or 14b). The interface server at (510) may be the same interface server shown in FIG. 3 (306), just at the data sources at (512) may be the same data sources shown in FIG. 3 such as database (308), administrator server (310), analytics server (312), blockchain (314), geofence (316), time (318), third party integrations (320), and proprietor portal (322), without limitation. Moreover, interface server at (510) may facilitate utilization of the forgoing, in the same manner or similar manner as described with respect to FIG. 3. Thus, in a sense, user device (14a or 14b), communication connection (504), interface server (510), and data sources (512) are shown in FIG. 5 just to help the reader visualize interactions detailed in FIG. 5.

Examples of rules that are detailed with respect to FIG. 5 include event rules and local rules, although embodiments are not so limited. Generally, an event rule is monitored by the platform (20) and if satisfied causes data to be pushed to one or more user devices (14a, 14b) and a local rule, when invoked, causes a user device (14a, 14b) to request data (i.e., pulls data) from the platform (20). An illustrative example of an event rule is if team “A” scores a touchdown, push a digital offer to all user devices (14a, 14b) that have scanned tags (16a, 16b). Here, the metric or trigger of the rule can be monitored (step 516) such as by directly sending a request or query to a data source (at 512) via the interface server (at 510), receiving data from the data source (at 512) on a regular basis such as every 5 seconds, 5 minutes, or the like (via the interface sever [at 510]), or combinations of both. The platform (20) may to monitor for the metric/trigger e.g., a touchdown (step 520) and continue to do so (step 522) until a metric/trigger e.g., a touchdown has occurred (step 520, yes). If the rule has been satisfied, the platform (20), can push the digital offer to all of the qualifying user devices (i.e., that have scanned a tag [16a, 16b]).

A more complex event rule may include more than one trigger/metric. For example, the rule may be that if team “A” scores a touchdown, push a digital offer for a free beer to all event users over the age of 21 that have used their user device (14a) to scan a tag (16a) in the venue (202). The first metric/trigger of whether a touchdown has been scored may be monitored as described above. The second metric/trigger may be monitored (at 518, 524) in the same or similar manner if the metric/trigger warrants, or it may be determined before or after the first trigger/metric has been satisfied. For example, since in this example the second metric/trigger relates to age, a query may be sent to one or more data sources (at 512) to find all users who are over the age of 21. Records stored on database (308), for example, may be consulted to look for age data in connection with unique ID data to determine if the person who has loaded the fan portal (218) on his/her device (14a) is of legal drinking age. As an alternative source of data or for any other reason, the interface server (at 510) may cause another data source (at 512) to be consulted to determine user age. For example, one or more third-party integrations (320) may have age information; thus, an API call or other query may be made to the third-party integrations (320) to obtain age data. As with the first example, if the first metric/trigger (step 520, no) is not met (i.e., touchdown), then the platform (20) continues to monitor the metric/trigger (step 522). If the metric/trigger (step 520, yes) has been met the platform (20) determines if the second metric/trigger (518) has also been met (step 524). Where the second trigger/metric has not been met (step 524, no) then the target on the user device (14a) is not updated (step 528), such as with the digital offer. Depending upon the rule, the second metric/trigger may continue to be monitored or not. For example, if the digital offer was to be sent only one time, then the rule is satisfied, and no additional monitoring is needed. If, however, the rule is to send the same digital offer (e.g., for a beer) every time team “A” scores a touchdown, the second metric/trigger would not have to be redetermined since even if the user turned 21 that day, the user's age would not change. Of course, if the event went past midnight, the rule could be structured to recheck ages after midnight. This does not mean that for a given rule a second (or third, or fourth, etc.,) trigger/metric would never need to be monitored. Should an additional metric/trigger be defined by a rule that needs additional monitoring, the method (500) will be allowed to do so. Going back to step (524), if the determination is yes, the digital offer may be pushed (526), such as via the controller (at 514, 506) to those users who have scanned a tag (16a) and who are at least 21 years old. Pushed content may update an element, such as a dynamic element, on a Web page, cause a popup to show on the user device (14a, 14b), send content to a digital wallet (24a, 24b), or any other way to push content as is known in the art. Such complex rules may be specifically desirable for providing access to or purchasing NFTs as a mechanism to limit even the opportunity to participate in these non-fungible elements.

Local rules, as an example, may be associated with one or more targets being utilized for a given event. Referring again to FIG. 2 as one example, each section (222, 224, 226) of seats may represent a grouping of tags (16a) such as student/discount seats, loge seats and all other seats. As such, when a tag (16a) is scanned by a user in section (222) the device (14a) may be redirected to first template of fan portal (218), when a tag (16a) is scanned by a user in section (224), the user device (14a) may be redirected to a second template of a fan portal (218), and when a tag (16a) in section (226) is scanned the user device (14a) it may be redirected to a third template for a fan portal (218). Thus, all users may be redirected to a fan portal (218), but each fan portal (218) may be based on a different template. In this way, a proprietor may deliver customized content to users in different sections based on the template to which the user device (14a) was redirected. Local rules, other elements, or both may be written into each template to further customize content, which in some instances may be on an individualized level. That is elements of application code may be rules built into the system to provide the content delivery determined by the system, or can be applied at an earlier stage, e.g., at a tag ID group target information (step 422), which can provide a different original redirect URL/target than is received by or directed to, for another tag ID in a different group.

Referring back to FIG. 5, the interface server (306, at 510) may determine, or cause to be determined, if there are any rules associated with a given template (e.g. for fan portal [218]) or another target. This is especially true where the rule may be designed as an event-type rule where content may be pushed to a device (14a). In this case, however, the rule may only be provided in a given template (e.g., for users sitting in loge seats). A given template, however, may also have local rules written therein. For example, a rule associated with a fan portal (218) template to be distributed to loge seats, may be if the user has season tickets, then include a digital offer for discounted season tickets for the following year. Thus, per this illustration the local rule may desire to pull/acquire (at 508) season ticket information before, during, or after the template for the loge seats is loaded on the event user device (14a). To obtain this data, the database may be queried (at 512), via the interface server (at 510), using the unique ID to check data records for the requested information (e.g., purchased season tickets). As with the push example, if the database (at 512) does not store such information, the information is inconclusive, the local rule requires confirmation from an outside source, or other such situations, other data sources (at 512) may be consulted via the interface server (at 510). If the local rule is satisfied, then a digital offer for discount tickets (next season) is sent to the template. If the local rule is not satisfied, then the template uses a “default” digital offer/content such as an ad for non-discounted season tickets, upgraded tickets for the next event to be held at the venue (202) or another, similar example. In an embodiment, data associated with the unique ID may be pre-analyzed to see if the local rule has been satisfied. Alternatively, data associated with the unique ID may be gathered (e.g., from a database, a third-party integration such as a ticketing service, or the like) and analyzed when the event user device (14a) makes the request. As yet another option, the data may be pre-analyzed and verified/checked for changes upon the event user device (14a) request. The interface sever (306) may take all of the variables from the target application code, template, rules, and the like and send requests/queries to the appropriate data sources or links to the data sources (at 512). The data sources may include data from the database (308), blockchain (314), geofence (316), timestamp (318), third-party integrations (320) such as data servers/databases, analytics server (312), and administration server (310), and a counter (at 512), without limitation.

In some implementations, a counter may be needed. For example, a counter may be enabled to maintain the countdown shown in FIG. 2 (216). A counter may be software on platform (20) that may be used as a counting mechanism for rules or other reasons. As such, the counting mechanism may be configured to meet the counting requirements of a rule or other counting need. As an illustration, a counter may count the number of tags (16a) scanned in a venue (202) during a particular event; count the number of tags (16a, 16b) scanned by a particular user device (14a, 14b) in a predetermined time window; count the tags (16a) scanned by a particular user during a particular event; count the number of times a user has interacted with the target delivered to that user device; count the number of user devices (14a, 14b) active at a given time, or other such non-limiting illustrations.

Thus, while a target is displayed on a particular device (14a, 14b), dynamic content may be seamlessly and dynamically updated/changed per coding/interactions between the user device (14a, 14b) and the platform (20). Certain dynamic changes occur through push and pull techniques such as those detailed by FIG. 5. However, dynamic updates/changes may further take place through the use of various third-party application programming interfaces (APIs) and their respective functionality. At a high level, the interface server (306) may connect, or may cause the third-party integration server (320) to connect, to third-party hardware/software (e.g., server) via one or more third-party APIs/API calls to access the respective third-party integration/functionality as is known or will be known in the art. Thus, third-party integrations/functionality may push or pull information through analytics server (312), retrieve it from database (308) or another data store, or combinations thereof, for real time/live streaming, updating, changing, and the like as is called for by rules/instructions associated with the target of the tag ID. Furthermore, embodiments allow for the use of interactive, two-way communications between user devices (14a, 14b) and the platform (20) such as via the socket server (324) and/or a socket API, or the like as is known in the art. Certain communications then end, upon the end of the event or where the user closes the application, where the communication (at 504) is severed.

As is also indicated in FIG. 5 at (508), the platform (20) may collect a large amount of data via user devices (14a, 14b). For example, after scanning a tag (16a, 16b) the platform (20) may receive data from the user device (14a, 14b) such as date, time, and GPS or other location, the device orientation (i.e., landscape, portrait), type (e.g., iPhone, Android), IP and other addresses, and operating system as a few examples. Thus, methods such as methods (400, 500, or both) may be configured to collect and aggregate data. Additionally, tools such as cookies, widgets, plug-ins, and similar tools may also be used to obtain data from user devices (14a, 14b). This, and other, information may be stored in a data source (at 512) such as database (308) or other data storage and in association with the unique ID. Data acquired using the aforementioned tools and other tools/techniques may relate to user engagement with a target such as a fan portal (218) as one non-limiting example. Such data may relate to digital offers presented to the user, digital offers downloaded by the user, products viewed by the user, purchases made by the user, to name a few examples. Such tools/techniques may also gather data relating to other user engagements such as total screen time, Internet browsing (times, sites/pages accessed, software used), updates to Web pages, other Web sites visited, the Internet, and the like. The user may also directly provide information via the user device (14a, 14b) such as by inputting personally identifiable information to obtain opportunities or offers such as unique information relating to user interests, user responses to questions, generic information about age or sex, or any other type of personally identifiable information. Such data is of high value to, for example, advertisers, proprietors, and the like, as it provides a large insight into consumer purchasing and Web browsing habits.

Data related to user devices (14a, 14b) may also be obtained from third party sources. As one example, when a query, request, or the like sent to a third party, the platform (20) may provide certain information with that query, request, etc., such as the unique ID, tag ID/target information, or combinations thereof. Thus, data returned by the third parties may also be stored (e.g., temporarily, or persistently) in association with unique IDs, tag IDs, target information, or combinations thereof. As one non-limiting example, service providers such as mobile/cellular providers may be queried to obtain information about user devices (14a, 14b). The unique ID identifying a particular user device may be sent to the service provider to obtain information about the particular device, or the service provider may provide information that may be later associated with a particular device. Either way, the platform (20) may collect and store information about users via the unique ID assigned to each user device (14a, 14b). As another non-limiting example, information associated with unique IDs assigned to user devices (14a, 14b) may be collected from various third-party integrations (320) such as in-venue/event metrics, integrated third-party metrics, ticket brokerage, and other tools, without limitation to the forgoing. In-venue/event metrics may include data collected relating to the venue, event, or both. For example, information relating to user purchases at the venue and/or during an event such as tickets, food, merchandise, and upgrades and the like may all be gathered and stored in association with the unique ID. Similarly, ticket brokerage integrations (e.g., 320) may be used to gather information from ticket brokers who sell tickets for the venue (202), event, or both, and may include a wide range of marketing data, not only about ticket purchases made, but also related information about the user. Thus, third-parties, including third party metrics integrations (320) may enable collecting information about users, user devices (14a, 14b), or both from third-parties including those who participate in a shared program or who sell or otherwise provide marketing information, demographics, and other data about the user.

In addition to collecting and storing data associated with unique ID, the platform (20) may analyze such data, which may or may not be recorded in association with unique IDs. Data analysis may occur while it is being collected, after it is collected and before it is stored, after storage, or combinations of the forgoing. Data, raw, analyzed, or both, may be stored in database (308) or another data store (at 512) such as blockchain (314), without limitation. The analytics server (312) may communicate with various aspects of the platform (20), to ensure data received from various sources is appropriately captured for decision making, analytics, and the like. That is, analytics server (312) may communicate with (either directly or via the interface server [306]), user devices (14a, 14b), third parties, third party integrations (320), time/timestamp (318), geofence (316), blockchain (314), database (308), even proprietor portal (322), or combinations thereof, so that data is captured as needed for desired analytics, decision making, and the like. For example, data may be subject to artificial intelligence analysis include machine learning/pattern recognition/deep learning as is now known or will be known in the art. Collected and/or analyzed data may be coupled with other information relating to the user/user device (14a, 14b), such as the unique ID associated with the user device (14a, 14b) for a variety of reasons, including content selection as one non-limiting example.

Content for display on user devices (14a, 14b) may be customized in numerous ways as has been detailed with respect to methods (400 and/or 500). Content may also be customized where data/data analysis shows that a user has, or group of users have particular preferences. These preferences may be utilized to modify content, such as advertisements that are delivered to that user/group of users. Furthermore, data analysis may allow the proprietor to generate rules specific to a user/group of users, send custom e-mails, push socket notifications or other messaging based upon the user's interactions/group of users' interactions with the platform (20), other such similar examples, or combinations thereof. Indeed, this provides for multiple opportunities for interaction and communication between the proprietor and the user to continue building relationships that can then be mined for longer-term relationships. As yet another implementation, the platform (20) may utilize unique IDs together with known information associated therewith to deliver unique advertising to users via third-party advertising services. For example, where available, the platform (20) has the ability to interface with advertising platforms to deliver a customized experience based on the user's search history or user information as a whole. Taking the forgoing together, it should be apparent that content provided to a particular user or group of users may be customized or modified as was described above with respect to FIGS. 4 and/or 5 and that data/information gathered as the user is engaged with the event target or the like, may be used to update/modify target content in real time, upon a subsequent scan of tag (16a, 16b) by the user device (14a, 14b), or both (e.g., at 508). For example, the socket connection (at 504) may be used to deliver pulled content, push content, notifications, and the like, and/or dynamically update content while the event is in progress.

Analytics may also determine which feature, elements, or the like provided by a target such as the fan portal (218) a user or group of users interact with the most or spend the most time viewing. Thus, advertising on high-usage pages, features, elements, etc. may come at a higher cost. In other words, proprietors may charge a premium to advertisers wishing to purchase the ability to place content, such as advertisements or digital offers on the pages or features of the fan portal (218) or other target that receive the most traffic.

The forgoing has been described largely with reference to a sports environment where event users can scan tags (16a) located proximate each seat (208)/other point of interest or remote users can scan MRCs (17b) that appear on a screen such as a television or computer display. Other environments may utilize the same sort of tag (16a) placement strategy, such as an artistic performance where tags (16a) may be placed proximate a seat. However, many artistic performances are not televised or otherwise visually distributed while the performance is taking place. Thus, these proprietors may enable an option for patrons at a specific donation level, or season ticket holders to remotely access the performance as the performance is taking place such as via an account on a Web site where the user can scan an MRC (17b). Alternatively, certain remote users may receive a digital communication such as an e-mail or physical communication such as a card or badge that is similar to a credit card having information encoded thereon so that the remote user can scan the MRC (17b) on the badge to access the target that is associated with the scanned MRC (17b). In this way, remote users that are unable to attend a particular live performance may still be able to enjoy the performance or features thereof via platform (20). And since the target for remote users may have distinctive features enabled (e.g., replays, filters) during a performance that are not available to an event user (so as to not distract the performers) the remote user may be able to watch the entire performance on the remote user device (14b) and access other target features during the live performance.

Concerts and concert/festivals (collectively “concerts”) may utilize the tags (16a) already in place at the venue (202) in which the concert is being held if the proprietor so allows; alternatively, concert proprietors may utilize a system that is not attached to the venue (202), or they may use both. As an example, concert proprietors may include tags (16a) separate from or integral with concert tickets, passes, credentials, or the like so users can scan (or click on if digital) the MRC (17a) to access the desired target. In an embodiment, the ticket, pass, credentials, or the like may be a badge or badge-like so that it can be attached to a lanyard, put in a wallet, etc. Lanyards may be distributed with the ticket, pass, credentials, etc., or they may be purchased. As an incentive to purchase a lanyard, the lanyard may be associated with its own tag (16a) and associated target (e.g., a digital offer). In an embodiment, remote users who are unable to actually attend the concert may still be able to enjoy certain aspects of the concert via the tag (16b) associated with a ticket, pass, credentials, etc. In an embodiment, remote users may opt to purchase just a tag (16b) so that they may enjoy certain aspects of the concert without being there. As one non-limiting example, the tag (16b) may enable the remote user to access live or recorded video of the concert, which would not otherwise be available without concert attendance.

In the case of schools and the like, tags (16b) may be linked to particular students and distributed to students and parents alike. For example, the student's tag (16b)/MRC (17b) may be on the student's school-issued ID or student-related identifier, and the parent's tag (16b)/MRC (17b), which may be the same as or different from the student's MRC (17b), may be distributed to parents on a magnet, badge, card, or the like so that the student/parent can simply scan their respective tag/MRC (17b) (with respective user device [14b]) to access a target (e.g., a Web page) with information relating to the particular student such as grades, classes, upcoming activities, as a few non-limiting examples. In fact, with respect to graduation, concerts, sports events and the like, a secondary target may be accessed via a link in the “primary” target, although embodiments are not so limited. That is, parents, teachers (with their own tag/MRC (16b/17b) to connect to the desired target), other employees and the like may access targets (e.g., a Web page or the like) for events relating to the school in more than one way. One way may be via the tag/MRC (16b/17b) that may be used on a regular basis as described above, or via tags (16b) permanently or temporarily placed at the school gym, auditorium, or the like, which will enable access to the event-specific target/target content.

Historic sites, museums, zoos, and the like may use any of the forgoing strategies and other unique strategies to enhance visitor experiences via one or more targets of a tag (16a, 16b). As one non-limiting example, tags (16a) may be located at or near entrances for users to scan with their devices (14a) to obtain the target. Additional tags (16a) may be located at, near, within, etc., various exhibits to provide supplementary content. In this way, the target of the tag (16a) may be streamlined and supplemented at-will. In an embodiment, users may buy merchandise/concessions via in-venue tags (16a) much like the stadium example. By making a purchase, the user may use a tag (16a) associated with the purchase to connect to yet another target for that particular tag (16a) such as a coupon, discounted entry tickets, and free entry tickets as a few non-limiting examples. In fact, with any of the forgoing examples tags (16a, 16b) may be placed on or with merchandise of all sorts to be able to access targets such as coupons and/or other incentives.

Several of the following figures detail specific uses cases and embodiments that flow from the diagram. In particular, the embodiments relate to the acquisition of NFTs, implemented through the system. A significant benefit of the elegance of the embodiments herein is the ability to implement certain rules, and even complex rules related to NFT purchases. Another benefit is the ability to verify both the right to be in attendance and actual attendance at a given event, meaning that a user has both a ticket and was actually using the ticket at the venue or event related to that ticket. These and other elements are explored in the several embodiments, which thus allow a user to use some or all of the steps, in any order, which can be used alone or together to scan a tag from a user device and to obtain an NFT.

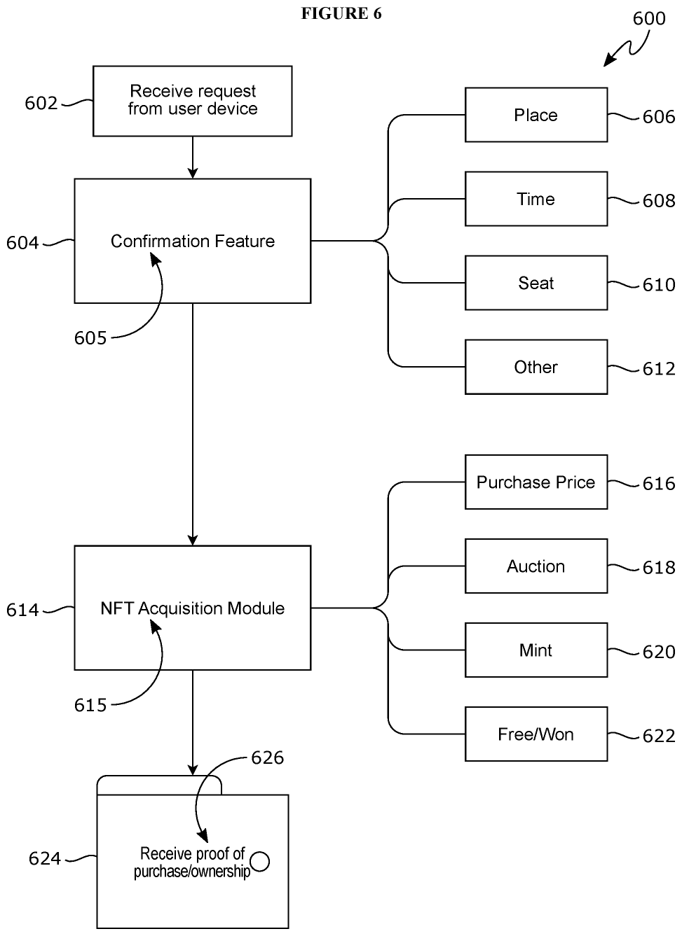

FIG. 6 details an overview of how a user may acquire an NFT per an embodiment of the present disclosure (method 600). Continuing with our in-stadium example of FIG. 2 and an exemplary infrastructure of FIG. 3, recall that the in-venue tag (16a) has a tag ID encoded thereon and the user device (14a) comprises a unique ID (22a) and a storage/digital wallet (24a). Preferably, the digital wallet (24a) includes the ability to buy, sell, and store crypto currencies and/or is linked to another wallet (not shown) that does. Thus, digital wallet (24a) may include a number of passwords and other barriers to entry. Before method (600) begins, the user scans the tag (16a) with user device (14a) and sends a request, which is received (step 602) to initiate method (600). This request may be the first request sent by the user device (14a), specifically to acquire an NFT, or it may be a request made via the fan portal (218) via a selectable option (220), which would have the appropriate label for NFT acquisition. In other words, user device (14a) as shown in FIG. 2 has already scanned tag (16a) on the seatback (210) in front of it and has gone through methods (400, 500) to be redirected to the fan portal (218) as has been described with respect to the forgoing methods. In this instance, however, the fan portal (218) may include a selectable option (220) that may initiate a request for an NFT without having to rescan the tag (16a).

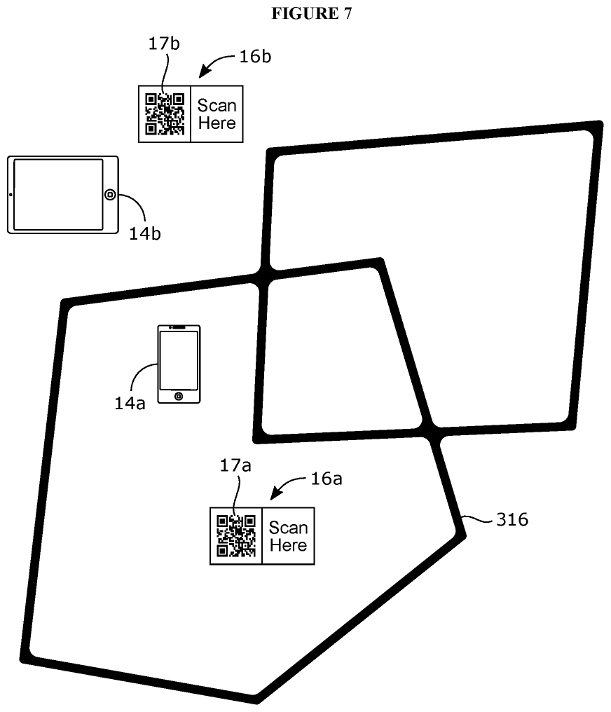

In response to the received request, the platform (20) may engage (step 604) an embodiment of a confirmation feature (605). Generally, the confirmation feature (605) confirms the place (606), time (608), seat (610), other conditions, limitations, requirements, metrics, or similar such standards (612), or combinations thereof. The degree to which confirmation is required may vary from embodiment to embodiment, which will become apparent from the examples provided herein. In an embodiment, the confirmation feature (605) is invoked upon an initial scan of the tag (16a) as described with respect to FIG. 4 as the place (606) and time (608) are confirmed or denied at steps (414, 418). That is, in response to scanning a tag (e.g., 16a) the platform (20) confirms the venue (202) in which the tag (e.g., 16a) was scanned (step 414), and that the time (608) of tag scanning corresponds to the time in which the event is in progress (step 418), as is described with respect to FIG. 4. Recall that the unique ID (22a, 22b), tag ID, and time of determination (method [400], step [418]) may be recorded for later use such as by confirmation feature (605). In certain embodiments this is all the confirmation that is needed to enable a user to acquire an NFT. In other embodiments, confirmation requires more than the initial confirmations provided at steps (414, 418), which are detailed in FIGS. 7-11.

In an embodiment where confirmation has been received by simply scanning the tag (16a, 16b) regardless of whether or not the tag (16a, 16b) is physically/digitally in the venue (202), the user may gain access (step 614) to an NFT acquisition module (615). The NFT acquisition module (615) may enable a user to acquire an NFT via paying a set purchase price (616), via an auction (618), via minting the NFT (620), or by accepting an offer for an NFT that was free or won (622). In an embodiment, the acquisition module (615) may be enabled by appearing on the user device (16a, 16b) in response to confirmation. As one example, the acquisition module (615) may be the initial target to which the user device (14a, 14b) is redirected upon scanning the tag (16a). Thus, if approved by the confirmation feature (605), the URL for acquisition module (615) may be sent to the user device (14a, 14b). See, e.g., method (400) at step (432). As another example, the acquisition module (615) may be represented as a selectable option (220), within the fan portal (218). The selectable option (220) may appear automatically or automatically unlocked upon additional confirmation by the confirmation feature (605) running in the background. Alternatively, a selectable option (220) may be “greyed out” or the like until enabled upon subsequent confirmation initiated by an attempt to select the “greyed out” version or a selectable “confirmation” option (220) or the like. Upon selecting the NFT purchase option, a landing page or the like may be displayed to guide the user through the appropriate acquisition process. Embodiments, however, are not limited to these examples.

In the instance where the desired NFT is being offered at a set purchase price (616), the simple act of supplying funds to buy at the set price results in the purchase of the NFT. In the instance where the desired NFT is being auctioned, those of ordinary skill in the art will recognize the auction (618) format, whether it is live or online bidding, and will also recognize how to win such an auction (618). Minting (620) in an embodiment, may occur in the situation where confirmation enables a user to upload an image (326a, 326b) from user device (14a, 14b) before proceeded with minting (620), or providing some other digital file to be minted. Depending on the minting services, the fees paid for minting may also purchase the NFT. Alternatively, purchasing the NFT may require an additional fee, which would be managed like a straight purchase (616). Similarly, the user may receive confirmation to acquire a free NFT or an NFT that the user has won (622), where instead of incurring fees, proof of purchase/ownership (626) can be provided upon the user's approval, such as via selecting an appropriate icon, button, or the like. In each of the forgoing examples, where appropriate, proof of purchase/ownership (624) may be sent via a crypto wallet (624), which may be or may not be linked to the digital wallet (24a, 24b). Furthermore, in an embodiment, NFT acquisition module (615) may be linked to one or more third-party NFT transaction providers that manage NFT related transactions including the sale (616), auction (618), minting (620), and other acquisition (622), of NFTs. The NFT acquisition module (615) may link to the third-party NFT transaction provider via a third-party integration (320), which may use one or more API calls to the third party NFT transaction provider as is known in the art, although embodiments are not so limited.

NFTs, however, by their nature are unique tokens. And, thus, there may be certain reasons why a particular user device (14a, 14b) may or may not be able to acquire an NFT, or where certain conditions must be met by the user device (14a, 14b) before being afforded the option to even bid at an auction or purchase an NFT outright. In one non-limiting example, the purchase of an NFT may be simply the conversion of a ticket, as owned by the user for that particular game, into an NFT. Here, the user would purchase the NFT, and such action would then mint the NFT, and would then serve as a verified token of the ticket for that game. In view of further embodiments detailed herein, several limitations may be put on the ability to make the purchase of the NFT for the ticket, including a given time (i.e., within a preset period, as a non-limiting example), at a particular location (i.e., within the venue), at the occurrence of an event (i.e., a particular team won, or some other metric occurred, as non-limiting examples), or that a user won a lottery or some other pre-determined metric for providing the right to acquire the NFT.

In embodiments where additional location information is needed before a user device (14a, 14b) is approved by the confirmation feature (605) the platform (20) may utilize a geofence (316). A geofence (316) may be thought of as a defined geographical zone that can be of virtually any size, or meet a particular limitation as needed for a particular embodiment. The limitations of how the geofence (316) may be used is, in some instances, dependent upon the limitations of the geofence itself (316). Thus, a geofence (316) may be created by any means known to those of ordinary skill in the art for defining the meets and bounds of an area.

In certain applications, the geofence (316) is the same as the venue (202) where the event is taking place. In other embodiments, the geofence (316) may be a section, portion, or other type of dividing scheme within the venue (202). In certain other embodiments, the geofence (316) is utilized for a much larger area, such as a state or a region. Generally, a geofence (316) works by receiving data from user device (14a, 14b), which is checked against the area defined by the geofence (316). The user device (14a, 14b) location is either within or outside of the geofence (316). Data receive by user device (14a, 14b) includes without limitation, coordinates for longitude and latitude, GPS coordinates, RFID data, WiFi data, or data from a mobile network, and other such examples. As is shown in FIG. 7, user device (14a), tag (16a), and MRC (17a) are within the geofence (316). Conversely, user device (14b), tag (16b), and MRC (17b) are outside of the geofence (316).

In some cases, the geofence (316) is used to try to prevent fraud. For example, some people may try to “beat the system” by taking a photograph of a tag (16a) in one location, such as a VIP area of a venue (202), to try to acquire benefits that may be awarded to that location, such as free drinks with the purchase of an NFT, or other benefit afforded from the tag (16a). If the geofence (316) defines only the VIP area, and the user device (14a) is not within the geofence (316), then confirmation is denied, and the user device (14a) is not enabled to acquire the NFT or the benefit of the NFT. In other cases, the geofence (316) may be used to open or limit opportunities to acquire an NFT, which is made clear in the examples. As one simple example, however, the geofence (316) may be used to give away an NFT to those user devices (14a, 14b) within the geofence (316). Thus, an NFT acquisition module (615) may be enabled on select user devices (14a, 14b) within the geofence (316). The geofence (316), however, may be used for any other reason that a user device (14a, 14b) location may need to be confirmed and is not limited to examples herein or NFTs in general.

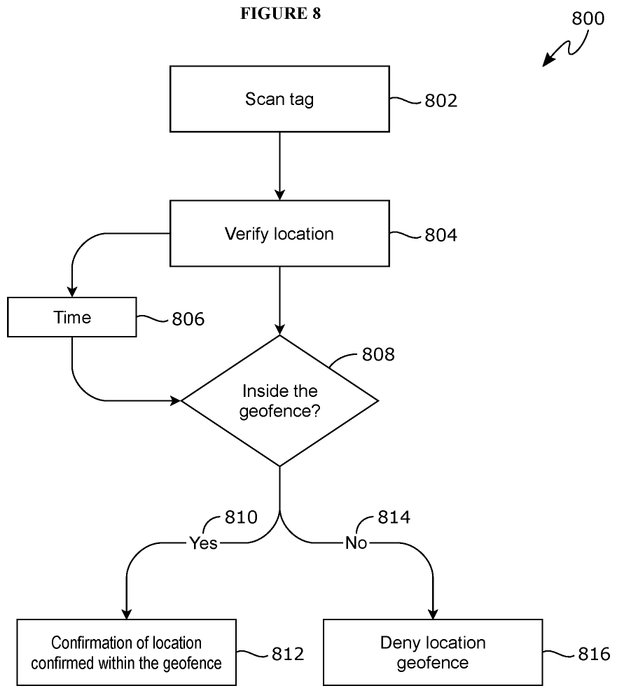

Again, taking the example shown in FIG. 2, an important, historical event has occurred during the game. The venue (202) displays the unique offer (214) on the jumbo screen (204) for a commemorative NFT related to the game, which is limited to the first 1000 users (or N users) at the stadium (216) who acquire the sequentially numbered NFT or the first 1000 users (or N users) are invited to bid on a certain number of NFTs with the NFTs going to the highest bidder(s). The jumbo screen (204) may also, for example, display an MRC (17a), although it is not shown in FIG. 2. An example of how the geofence (316) may be beneficial in this scenario is detailed in FIG. 8.

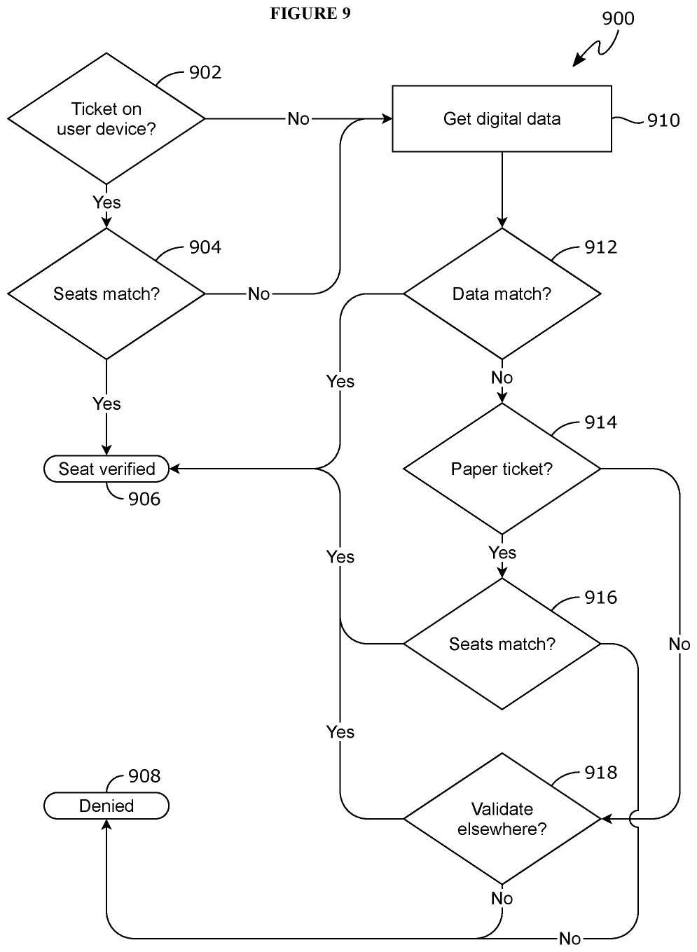

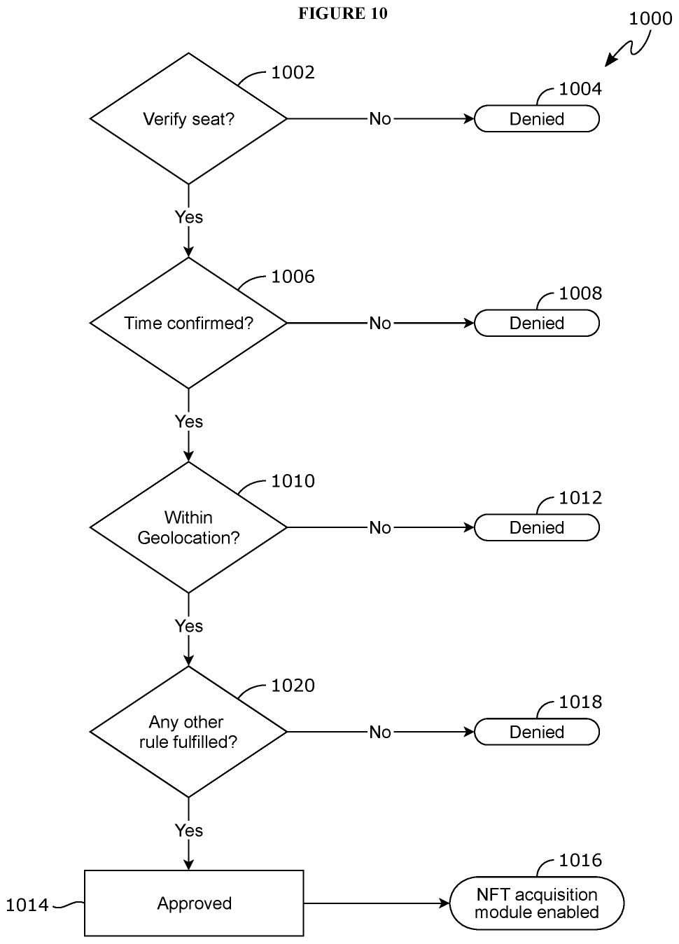

At step (802), the platform (20) may receive a request for the NFT from many user devices at the same time due to the MRC displayed on the jumbo screen (204). The tag ID for the tag (16a)/MRC (17a) on the jumbo screen (204) would indicate that the venue exists, and the event is in progress per method (400). Since the jumbo screen (204) may be shown on a national broadcast of the game, or a user at the stadium has recorded the unique offer (214) and posted it on social media or other such situation, the location (step 804) of the requesting user devices (14a, 14b) may be checked to determine if it is within the geofence (316). In this example, the time (608) of the request (step 806) may also be checked to ensure that the requesting user device (14a, 14b) is within the geofence (316) at the time (608) the request has been made (step 808). As a non-limiting example, the time (608) may be checked (step 806) by consulting the recorded time data that was associated with the unique ID and tag ID when the request was made or via a time check (318), as is generally known in the art. If the user device (14a) is within the geofence (316, step [810]), then the user device (14a) is approved or confirmed (812) by the confirmation feature (605) and the NFT acquisition module is available to the user device (14a). If the user device (14b) is not within the geofence (316, step [814]), the user device (14b) is not approved by the confirmation feature (605) and the user device (14a) is unable to acquire the NFT (step 816). To finish the example, after the first 1000 in-venue users have acquired (216) the offered sequentially numbered NFT, the unique offer (214) is disabled and any further attempts to acquire the offered NFT are redirected as appropriate, such as a page indicating that the offer has expired, or redirected to a home page, or venue page as determined by the proprietor. Thus, if the user device (14a, 14b) is inside the prescribed geofence (316) at the given moment the determination (step 808) is made, then the user device (14a, 14b) may be approved by the confirmation feature (605), or it may have to undergo additional confirmation as is described with respect to FIGS. 9-10. For the geofence (316) to be of use in any particular instance, the meets and bounds of the geofence (316) must be set. Furthermore, since time (608) was also used by the confirmation feature (605) in this example, it is possible that the user device (14a, 14b) may be within the prescribed physical location of the geofence (316), but at the wrong time (step 806), and for this reason may be denied confirmation. Embodiments, however, are not so limited, as it may be suitable to have met the geolocation at any time (608). The exemplary process (800) of checking whether a user device (14a, 14b) is within a predefined geolocation is simple, but elegant in allowing for confirmation related to location at the exact time of scanning the tag (16a, 16b), and such information is difficult to fake.

FIG. 9 details a further embodiment of the confirmation feature (605) wherein the rights and/or privileges afforded to a given seat in a venue (202) are approved as one example. Returning to the example of FIG. 2, in this scenario, the user purchased a ticket for seat 1, row A, section 100. Certain rights/privileges may be associated with that exact seat. Thus, the confirmation feature (605) may need to confirm that the user sitting in seat 1, row A, section 100 is the same user that purchased the ticket for the seat. If not, the user sitting in the seat may not be entitled to any rights and/or privileges that come with seat ownership for the event.

As one nonlimiting example, seat 1, row A, section 100, may have a special meaning or value associated therewith for a given event, or may grant the owner of the seat some benefit. In this example, the venue (202), had an NFT lottery and the winner is granted the ability to acquire the NFT whether it is free, part of an auction, straight purchase at a given purchase price, or the ability to mint a digital file uploaded by the user. Seat 1, row A, section 100 is the winning seat of the lottery. Thus, confirmation feature (605) may seek to ensure that the user device (14a) requesting the ability to acquire the NFT is associated with the user that purchased the ticket for the winning seat and not from someone else. There are many examples of someone not being in the right seat, due to user error, or simply someone picking a different seat than one in which they hold a ticket. In other, more sinister instances, a tag (16a) could be imitated, such as a photo or recreation of the tag (16a), for someone seeking to obtain the rights and privileges to that tag (16a), without actually having the rights to that tag at the given moment or event, i.e., you must actually have owned that ticket for that seat.

Thus, the ability to identify and confirm the right to sit in a particular seat, i.e., the user actually has the ticket for the seat in question, may have value to both the venue (202) and the user who holds the ticket for the particular seat. In the past, holding a paper ticket/ticket stub for a given seat, confirmed that that the user was at the game and sat at a particular seat. Today, many users opt for digital tickets, which may require an alternative to confirming that the user of the device (14a) also holds the ticket for the winning seat.

For the present example, the right to be in the particular seat and to have the right to scan that tag (16a) for that seat is limited to the person holding the ticket to that seat. What is not known is whether the person scanning that tag (16a) has the right to be in that seat. As such, the confirmation module (605) may utilize some or all of a seat verification method, such as method (900). Method (900), in this example, is being used to verify that a user holds the ticket for seat 1, row A, section 100 so the user can claim his/her NFT. It should be noted that method (900), may be called in response to scanning a tag (16a) on the seatback (208) in front of the user or in response to selecting an option (220) from the fan portal (218). Thus, some or all of the method (900) may be incorporated into method (400) when the confirmation module (605) confirms place, time, and grouping (FIG. 4, steps [414, 418, 422]), method (900) may be invoked thereafter as a separate method, or some steps of method (900) may be called on during method (400) and other steps of method (900) may be called on after method (400). In other words, the confirmation feature (605) may call on one or more steps for seat verification (method 900) when the confirmation feature (605) needs to use those steps.

In certain embodiments, the NFT confirms ownership of an original, digital file. The digital file, in certain embodiments includes a tag, such that, by accessing the NFT by the owner, and scanning a tag, which is the subject of the NFT, that scan of that tag within the storage system of the NFT is what confers the benefit. Thus, as each tag is uniquely coded, the specific tag in the NFT would be tied to the owner or unique ID, so as to be validated for the particular benefit being afforded.

Referring to FIG. 9, the method (900) may be used to determine if the user device (14a) requesting to acquire the NFT holds a digital ticket file thereon (step 902). For example, confirmation feature (605) may look to the digital wallet (24a) associated with the user device (14a) that scanned the tag (16a) to see if it has a ticket for seat 1, row A, section 100. In some instances, the redirect/identification server (302), socket server (324), or similar such server, may call back to the user device (14a), to see if the digital ticket file is present. Where a digital ticket file is found (yes), ticket data can be used by confirmation feature (605) to determine if the seat on the digital ticket matches (904) the seat associated with the tag (16a). Thus, the confirmation feature (605) knows which user device (14a), via the unique ID, is being used at a particular seat. In the case of seat 1, row A, section 100, if this is the seat designated by the digital ticket and it matches the seat associated with the tag ID (i.e., seat 1, row A, section 100, step [904]), then the confirmation feature (605) may verify the user's right to the seat (step 906). Once verified (step 906), the NFT acquisition module (615) may be enabled.

If, however, a digital ticket was not found on user device (14a) (step 902, no) or the digital ticket data does not match with tag ID data, (step 904, no) then the confirmation feature (605) may look elsewhere to try to verify that the correct user is sitting in the correct seat. As one non-limiting example, the confirmation feature (605) may use a third-party integration (320) to make an API call to a third-party ticket seller, in-venue ticket seller, or the like, to try to verify that the user device (14a) used to scan the tag (16a) associated with seat 1, row A, section 100, is the seat in which the person using the device (14a) is entitled to sit. For example, the ticket seller may obtain certain personal identifying information when a ticket is bought. Such information may include, but is not limited to name, address, phone number, credit card information, or another set of data that may be used to determine if the user device (14a) that scanned the tag (16a) has the particular right to the given seat during the event in progress. Thus, the API (or other) call may provide other digital data (910) that may or may not match (step 912) the tag ID data and/or unique ID data. An example where seats may not match at step (904), but data may match at (912) is where the user of the device (14a) purchased several seats at the same time, such as where a family purchased five tickets for the game. In reality, the same user may have purchased all of the tickets, but the ticket on user device (14a) is for the next seat over, or that particular device (14a) does not have any digital ticket stored thereon. Either way, data from the ticket seller may confirm (step 912, yes) that user holding user device (14a), is indeed entitled to make a request to acquire the offered NFT (step 906). Alternatively, digital data may be obtained from user information, such as an email, credit card, phone number, address, or other data related to the purchase of that seat. Nevertheless, if such data is absent or proves deficient (step 912, no), then a determination may be made to see if a paper ticket (step 914) is available to allow seat verification via the confirmation feature (605).

If a paper ticket is produced (914) and the seat on the paper ticket matches the seat associated with the tag ID (i.e., seat 1, row A, section 100) (step 916, yes) then the confirmation feature (605) may verify the seat (step 906). For example, paper tickets frequently have a code or other information printed thereon that can be scanned to verify the information on the ticket for this purpose. If no (step 916, no), then seat verification is denied (step 908).

Returning back to step (914), if the user does not have a paper ticket (step 914, no) then the user may request verification via an alternative validation source, such as an entity, other than previously consulted, that may have provided the ticket (step 918). Such an example may be that the user bought the ticket from a friend and did not transfer the electronic file related to the ticket. A simple text or email to the friend may allow the user to get the necessary information to validate (step 918) and, if upon re-running the process the requisite data matches (step 918, yes) the seat is verified (step 906). Otherwise, seat verification is denied (step 908).

In each of the processes that may be utilized by the confirmation feature (605), user device (14a) approval with respect to a particular tag (16a), hence the seat, is an initial, gatekeeper function, which may be simple or complex depending upon the certainty desired under the circumstances. Confirmation may be heighted when granting rights enabling user minting of an NFT. That is, a user may mint an NFT for a digital file (326a, 326b) such as a photo, video, digital ticket, etc., that the user created at the event without specifically being granted the right by the proprietor. Like many unique items, however, the story behind the subject matter may influence the subject matter's value. Thus, an NFT that is minted after approval from the confirmation feature (605) may add to the desirability (i.e., value) of the NFT. This is especially true where confirmation feature (605) approval is due to some limitation or special circumstance making that particular NFT very scarce, hence increasing its value. For example, the venue (202)/event may hold a lottery where a given seat at the venue (202) is revealed as the winner. The NFT from this win may be the only official NFT one provided for the subject matter therefore increasing its value. In other non-limiting examples, a contest winner, a purchase made, a prize awarded, or any other reason may limit the right to acquire an NFT via scanning a given tag (16a, 16b). As such, the confirmation feature (605) may require multiple levels of confirmation to be satisfied.

Referring to FIG. 10, an embodiment is shown where at least three distinct levels of confirmation above the basic level of confirmation (e.g., method [400]) must be achieved before the requirements of the confirmation feature (605) are satisfied, such as when granting a particular user the ability to mint a user-produced digital file. Having this ability may affect the value of the resultant NFT, thus making it desirable to the user. On its own, anyone can mint an NFT. However, this is analogous to the art world, where anyone can print a copy of the Mona Lisa, but only the real painting is priceless. Thus, an NFT that was issued by a team, for a particular reason, has subjective value that is built into the value of the NFT, instead of just a one-off user minted NFT. Thus, as with method (900), various steps of method (1000) may be utilized by the confirmation feature (605) as required by specific circumstances. Furthermore, entry into method (1000) may be immediately after scanning a tag (16a, 16b) or after selecting an option (220) on the fan portal (218). Thus, method (1000) may begin with a determination of whether the seat can be verified as described with respect to FIG. 9. Seat verification per method (1000) may implement some or all of the seat verification steps of method (900). If the seat cannot be verified (step 1002, no), the requesting user device (14a) is denied (step 1004) access to the NFT acquisition module.

If user device (14a) passes the seat verification step (1002, yes), then any time requirements (1006) may be confirmed. Generally, the confirmation feature (605) may determine if the NFT is available at the moment when it checks the time requirements. For example, the NFT may only be available during a set window such as 10 minutes after the first touchdown of the game, as one non-limiting example. To make such determination, the time (318) from an official time keeping element, as is known in the art, may be consulted, and compared to the time set for NFT availability. If the time is confirmed, i.e., the request for the NFT was made while window is open (step 1006, yes), the method (1000) may progress to a geolocation check. If not (step 1006, no) then the user device (14a, 14b) is denied (step 1008) the opportunity to acquire the NFT.

In an embodiment, geolocation determination is made via consulting the geofence (316), as was described with respect to method (800). That is, some or all of the steps associated with method (800) may be utilized by the confirmation module (605) to verify geolocation. If user device is outside the prescribed geofence/geolocation (step 1010, no), then the user device (14a) is denied (step 1012) the ability to acquire the NFT. If, however, the user device (14a) is within the geofence/geolocation (step 1010, yes), then the user device (14a) is approved by the confirmation feature (605) and the NFT acquisition module is enabled (1016). Thus, FIG. 10 details how a proprietor, venue, event, or the like can limit the rights to acquire an NFT through several levels of verification, confirmation, and the like related to the scan of a single tag (16a).

Notably, each of the steps regarding seat verification (1002), time confirmation (1006), and geolocation verification (1010), can be used independently or together, based upon the given rules for the NFT release. Indeed, step (1020) simply determines after any one or all of the prior confirmation features if any other rules are in place, and if any such rules are not fulfilled the acquisition is denied (step 1018). As defined in FIG. 5, certain event rules (514) may be implicated in the release of the NFT. Thus, before the NFT is authorized for purchase, such confirmation and check of any other rules is necessary.

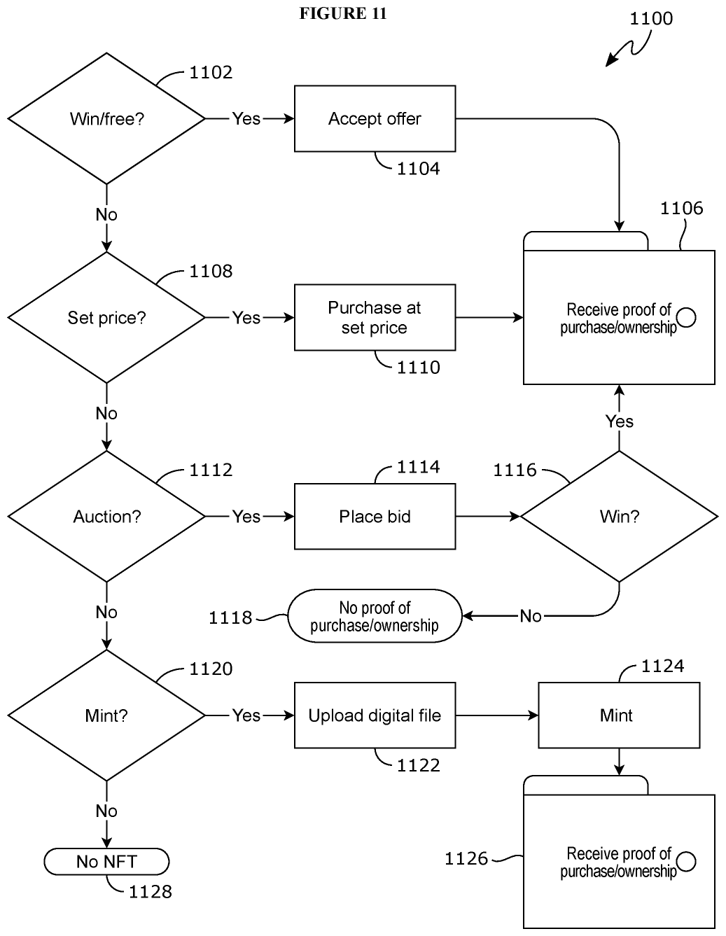

FIG. 11 details an embodiment of a method (1100) that may be employed by the NFT acquisition module (615), with the goal of acquiring an NFT through purchase (616), auction (618), minting (620), or free/won (622). Typically, the NFT acquisition module (615) is enabled upon approval by the confirmation feature (605) as has been described above, although embodiments are not limited thereto. If the user is acquiring the NFT because the user won it or it was offered for free (step 1102), then simply accepting the offer (step 1104) provides proof of purchase/ownership (step 1106). If the user did not win or otherwise obtain the NFT for free (step, 1102, no) and is instead purchasing the NFT at a set price (step 1108, yes), the user may buy (step 1110) the NFT to obtain ownership (step 1106). If, however, the user is bidding on NFT in an auction (step 1112), rather than purchasing the NFT at a set price (step 1108, no) then the user may place a bid (step 1114) on the NFT. If the bid is a winning bid (step 1116, yes), then the user receives proof of NFT purchase/ownership (step 1106). If the user did not win the auction (step 1116, no), then the user does not own the NFT (step 1118). If, however, the user desires to, or wins the right to mint a digital file (step 1112, no, to step 1120) such as digital file (301a), the user may select the digital file (301a) to be uploaded (step 1122) to the platform (20) and stored in either a temporary storage or database (308) for minting (step 1124). In an embodiment, the venue (202)/event proprietor may provide the digital file (301a) to be the subject matter of the NFT. Alternatively, the user may provide the digital file (301a). The digital file (301a) may be a particular replay of the game, a picture of a particular player, artist, or performer, an image of a given seat, an image of the final score, a simple digital image of some other artwork or sports-memorabilia, or virtually any other item that is a digital file or is recorded as a digital file such as a video or an image of physical subject matter. In certain embodiments, the digital file in the NFT may further comprise a tag or a MRC, which can then, itself, be scanned.

Minting (step 1124), purchasing (step 1110), and other ownership rights (e.g., steps 1116, yes, and 1104) in an NFT may be through one or more exchanges/marketplaces that mint, list, and/or sell NFTs. In an embodiment an exchange/marketplace may be available via a third-party integration (320), which may use one or more API calls to complete a transaction. In other embodiments, the user may be provided with options to go to the user's exchange/marketplace of choice (e.g., outside of platform [20]) where the transaction may take place. Thus, minting (step 1124), as with the other acquisition options, is not limited to utilizing a third-party integration (320). Nevertheless, when the desired transaction is completed, interface server (306) or other suitable server may communicate directly with a blockchain (314), indirectly through a third-party integration (320), or both, to record the transaction (e.g., ownership/change of ownership). As one non-limiting example, the interface server (306) may access the digital wallet (24a) and/or another crypto wallet (not shown), to provide funds for the transaction, whether it be winning an auction, purchasing, or minting. Upon minting (step 1124), “lazy minting”/purchase (step 1110), or other acquisition method, the interface server (306) may be utilized to record the NFT on the blockchain (314) and provide proof of the transaction to the appropriate parties' digital wallets (24a, 24b) or another necessary crypto wallet (not shown) (step 1106 or 1126). Of course, the user has the option to exit the NFT acquisition module (615) without acquiring an NFT (step 1120, no, to step 1128).

### EXAMPLES

EAMPLE 1: The confirmation feature (605) may also be used to place additional limits (612, other) on a user's ability to acquire an NFT through the NFT acquisition module (615). For example, the user may be at game 7 of the National Basketball Association (NBA), where the winner of the game will be the champion. The user believes that the tickets for this game will likely have value to at least some fans, because it relates to the winning of a championship. In this scenario, however, a commemorative NFT will only be released to in-venue users when the first team scores 100 points in the game. Any attempt to acquire an NFT before 100 points have been scored would result in the NFT acquisition module (615) being blocked. In other instances, the time may simply be a set time, and not reliant on some action in the event. Thus, a rule is implemented within the system to limit when the NFT is released.

Referring to figures described herein, the user device (14a) may be used to scan a tag (16a) on the seatback (210) in front of the user. The platform (20) will check to see if the event is occurring at the place acknowledged to be hosting the event. See, e.g., method (400). If so, the user device (14a) will be redirected to either the fan portal (218), where the user may select an option (220) to try to obtain the NFT or may be subject to additional approval by the confirmation feature (605) as is determined by the event or venue (202) proprietor, or some other authority. If additional approval is required, then under both scenarios the confirmation feature (605) may utilize one or more of a seat verification method (e.g., FIG. 9), a time verification method (e.g., FIG. 10), or a geolocation method (e.g., FIG. 8). Since the method of FIG. 10 (method 1000) utilizes one or more of the steps from each of the aforementioned methods, reference will be made to this figure.

Thus, at step (1002), additional approval by the confirmation feature (605) would look to a seat verification method such as some or all of the method (900) detailed in FIG. 9. If the seat is not verified (step 1002, no) then access to the NFT acquisition module (615) is denied (step 1004). If the seat is verified (step 1002, yes), then the confirmation feature (605) may utilize a time conformation method (step 1006). In this example, the timing of the request must coincide with 100 points being on the score board, this functions as a rule (1020). In one instance, the platform (20), via interface server (306) may determine if 100 points has been scored, such as by a query to the database (308), third-party integration (320), or other such resource. In another instance, the platform (20), may have data relating to the time that the 100th point was scored. Thus, the interface server (306) may be used to determine the current time (318) and the time that the 100th point was scored such as a database (308) or third-party query (320), although embodiments are not so limited. If the confirmation feature (605) determines that the time of the request is after the 100th point has been scored (step 1006, yes), then the confirmation feature (605) may be called on to determine the geolocation (1010) of the user device (14a), otherwise, approval is denied (step 1006, no to step 1008).

The confirmation feature (605) may then call upon the geofence (316) to determine if user device (14a) is at the venue since the offer is only available to in-venue users who are the physically present at the venue (202) hosting the championship game. Thus, a geofence (316) would be provided around the venue (202). If the user device (14a) is within the geofence (316), as determined by a method that is the same as or similar to method (800) then the confirmation feature (605) finally approves (step 1014) the request for the NFT and the platform (20) enables the NFT acquisition module (step 1016). If however, the user device (14a) is not within the geofence (316), then the user device (14a) is denied access to the acquisition module (step 1012). After being enabled, the NFT acquisition module (615) allows the user to acquire the commemorative NFT, such as by a method that is the same as or similar to method (1100), as one non-limiting example. Accordingly, one can see the simple elegance of multiple steps to confirm the right to seek purchase of an NFT and the implementation of certain rules.

EAMPLE 2: Still relying on the championship game example described with respect to Example 1, assume 20,000 people are attending the game and 5,000 randomly selected seats will be approved to participate in an NFT auction to by a one-of-a-kind image of the final, winning goal, which won the game as the clock counted down to zero. The auction window is opened for 10 minutes (after the game is over). The confirmation feature (605) may utilize a process similar to the processes described above with respect to Example 1, with an additional determination with respect to seat verification to ensure that the tag (14a) scanned is associated with one of the randomly selected seats, such as using the interface server (306) to do a lookup to compare to see if the tag ID extracted from the user device (14a) request corresponds to a seat associated with a winning seat. Such lookup may be performed before, during, or after a seat verification process such as method 900 detailed in FIG. 9. Further, the confirmation feature (605) will also perform a time check as has been described to ensure that the request from the user device (14a) is within the 10-minute window. If the confirmation feature (605) approves the user device (14a) request for the NFT then the NFT acquisition module (615) may be enabled. In this scenario the NFT acquisition module (615) provides for an on-line auction format or access to an online auction. Thus, up to 5,000 users may bid at the online auction and when the 10 minutes is over, the highest bidder wins the auction (e.g., method [1100], step [1116], yes). Upon payment of the bid price the user owns the NFT and receives proof of purchase (e.g., method [1100], step [1106]). The remaining users do not receive proof of purchase/ownership (e.g., method [1100], step [1118]). The forgoing is a use case for bidding on NFT, instead of a direct purchase, and embodiments are not limited to this Example.

EAMPLE 3: Certain events/venues (202) such as outdoor concerts or arts venues (202) may provide a tag (14a) on a lanyard, paper ticket, badge or pass as a few examples. In some instances, the venue (202) includes multiple stages or even multiple locations, and a badge, pass, or similar type of portable is needed to access all stages or locations. Thus, it may be particularly important to use a geofence (316), if desired, to confirm that a user device (14a), scanning a tag (16a) on a badge or pass, is actually present within a geofence (316) to be authorized for the NFT. Thus, if a badge or pass is not being utilized, and is not at the venue (202), it will not be in the geofence (316) and thus not authorized. Such a method (e.g., method [800]) provides some authenticity to the process, where it confirms that a user device (14a) was actually present in the location, at a given time, and was authorized to be in that space. Thus, an NFT purchased under that scenario means that the user was actually present at the event or venue (202).

EAMPLE 4: An administrator (e.g., for the proprietor via portal [322], of the platform [20], via the administrator server [310], or both) has the ability to set an infinite number of variables (i.e., FIG. 6, [612]) that the user must meet in order to gain the right to mint, purchase, bid-on or otherwise acquire an NFT. These variables may relate to completing tasks or visiting certain locations within a venue or geographic region such as: (i) scanning N number of tags in a geographic region such as Philadelphia wherein the location of the tags is known from the tag ID; (ii) scanning N number of tags in a geofenced (316) area such as Central Park wherein the location of the user device (14a) is known within the geofence (316) so that the tags do not need to be stationarily mounted (i.e., the tag could be mounted on a vehicle capable of leaving the geofenced [316] area); (iii) scanning N number of tags within a defined amount of time (i.e., one hour, one day, one week, one month, etc.); or (iv) any combination of the foregoing. In these instances, multiple user devices (14a) may scan one or multiple tags (16a, 16b) to meet the defined variables or one user device (14a, 14b) may need to scan multiple tags (16a, 16b) to meet the defined variable. For example, within a museum, a user may be required to visit certain exhibits for example, a sculpture in the Renaissance section, a painting in the Impressionist section and a photograph in the modern art section. Each work of art has a tag (16a) associated with it. In this example, each tag (16a) has a tag ID that is uniquely coded to include information about the work such as the title, artist, and physical location within the museum (i.e., in the Renaissance wing). When a user device (14a) scans the tag (16a), the platform determines if the user device (14a) has unique ID (22a) already assigned to it and if not, assigns the user device (14a) a unique ID (22a), as is described with respect to FIG. 4. In this instance, the interface server (306) may update the record for the unique ID to indicate that the tag was scanned. Such an update may occur, as one non-limiting example, at step (430) of method (400).

As the user continues her visit at the museum, she continues to scan tags (16a) with her user device, the platform (20) updates her user record each time the device (14a) associated with the unique ID scans a tag (16a). In this way, the record associated with the unique ID also notes which tags have been scanned. Once the tag IDs stored on the user record match the variables determined by the system administrator, the acquisition module (615) is launched as detailed above in FIG. 11 and the user may (i) mint her own NFT, (ii) purchase an NFT, (iii) obtain an NFT at no cost, (iv) or bid on an NFT (i.e., in a charity auction, or simply for sale by auction), as these options have been predetermined by the system administrator or the proprietor. In this way, events can become a scavenger hunt, wherein clues or required elements are necessary to open the right to purchase the NFT. In certain embodiments, the particular locations can be displayed on a GUI or generated to allow the user to traverse through the necessary sections of the museum to meet the requirements for obtaining the NFT or right to bid on the NFT.

EAMPLE 5: In another embodiment, a venue (202) may wish to make an NFT available based upon an occasion at the venue. For example, a zoo may wish to offer an NFT to commemorate the birth of a new baby animal or a winery may wish to offer an NFT to commemorate the release of a vintage. In this instance, the venue may (i) choose to make one NFT available for purchase, such as via auction, thus increasing the value of the NFT; (ii) offer the NFT for sale to all users who meet certain parameters as determined by the venue or administrator by minting multiple unique tokens at the same time, with a limited or finite number in circulation that will not be increased; (iii) allow users to mint their own NFTs if the user has met certain parameters as determined by the venue or administrator; (iv) allow users to obtain an NFT at no cost, or a combination of the above. Likewise, the venue may mint one NFT with one unique token, or mint multiple unique tokens for the same/similar NFT, with a limited or finite number in circulation that will not be increased.

In the example of the new baby animal at the zoo, the administrator determines the parameters that must be met by a user in order for that user to be granted the right to mint, purchase, bid-on or otherwise acquire the NFT. For example, the user may be required to scan the tag located near the animal's habitat during certain time parameters set by the administrator. Or the user may be required to scan a certain number of tags within a geofenced location as described in FIGS. 7 and 8 with or without the parameter of time. Likewise, in the example of a release of a wine vintage, the administrator may set the parameter of scanning a tag within a geofenced location as described in FIGS. 7 and 8 within a time parameter. Thus, a particular embodiment may be defined by a fundraiser related to the baby animal. The zoo determines that an NFT of the first view of the animal is provided, and that the ownership of the NFT confers some additional rights, namely, that the owner of the NFT is able to name the baby animal, visit the animal when at the zoo, or some other special offer. Here, the zoo requires a user to scan at least three different tags within the zoo, as well as have purchased a ticket to the fundraiser. Thus, users who have met the limitations are then afforded the unique right to bid on the NFT to earn the NFT and the rights conferred by its ownership.

In the various embodiments herein, the NFT may confer certain unique rights to the owner, as determined by the administrator or proprietor. Thus, the purchase of said NFT may not only give the intrinsic value of the NFT, but also those supplemental rights. Within a venue, such NFT rights could include, but are not limited to: free beverages or food, special rights or entry, specific seat upgrades, backstage access, discounts to tickets, merchandise, or other materials at the venue, special discounts related to wagering, or other tangible benefits that may be given by a proprietor at a given venue. Thus, the ownership of said NFT may have value to the user beyond its intrinsic value.

In either event, users at the respective venue scan tags (16a) with their user device (14a) to initiate a method that is the same or similar to method (400). The confirmation feature (605) may use the data in the record associated with the unique ID to determine if parameters set by the administrator have been met by the user device (14a) such as place and time. That is, the tag (16a) scanned by user device (14a) transmits its tag ID to the platform (20). From this, the method (400) can determine that the particular tag is at the venue and is associated with the particular location such as the habitat or the like. The confirmation feature (605) may also use the tag ID to ensure that an event is in progress per method (400), step 418. The confirmation feature (605) may also use the geofence (316), time (318) or both as has been detailed with respect to FIG. 8. The confirmation feature (605) may also use any other form of approval at its disposal and as described herein. If approved by the confirmation feature (605), the acquisition module (615) may be launched so that the user may mint, purchase, bid-on or otherwise acquire the NFT. Indeed, an embodiment of minting an NFT as detailed in FIG. 11 may be utilized wherein a digital file (301a) is uploaded by a user device (14a) and minted as an NFT.

EXAMPLE 6. To expand upon Example 5, not only may the venue want to make a NFT available based upon an occasion at the venue, but it may also want users to be able to acquire an NFT based upon the user's verified location. For example, when venue such as an amusement park debuts a new rollercoaster, the venue can offer users the ability to mint or otherwise acquire an NFT specific to the seat in which they sat. In this example, tags (16a) having MRC's (17a, 17b) have been installed in, on or by each seat of the rollercoaster, or in the queue before or after users enter and exit the rollercoaster cars. Each tag ID is uniquely coded to the seat location so that the system knows if the tag (16a) is in the first row, last row, or any row in between.

The administrator may set any number of parameters required to make the NFT available to the user, for example, the tag must be scanned within one hour of the venue opening on the day the rollercoaster debuts, or the tag must be scanned within one week of the day the rollercoaster debuts. Likewise, the administrator can set additional parameters such as the user has N number of minutes from the time the tag was scanned to mint, purchase or acquire the NFT or the NFT is no longer available to the user.

When the user device (14a) scans the tag (16a), the system follows the steps previously detailed above available to the confirmation feature (605) including time determinations using platform resources such as time (318), data stored in database (308) or other data storage, third-party integrations (320) or the like to meet the specific parameters required for confirmation. Once approved by the confirmation module (605), the acquisition module (615) is enabled and the user is able to mint, purchase or otherwise acquire an NFT commemorating that he rode the rollercoaster on the day it debuted (or other time parameters as established by the administrator or the proprietor) in the front row (or specific location of his scan) per one or more steps detailed in FIG. 11.

EXAMPLE 7: For some of the world's most viewed events, attendance space is limited, and a substantial percentage of the population may watch the event in real time via a video feed; for example, the Superbowl, the Olympics, or the New Year's Eve celebration in Times Square. However, oftentimes these events become culturally or historically relevant because of something that occurred during the event, such as a spectacular play within a game, the last performance by an Olympic athlete, watching the ball drop on Dec. 31, 1999. Users who are not among the limited number of people attending the event at the venue may still wish to document that they viewed the event as it happened.

In an embodiment of the present invention, a tag (16b) or “tag less” MRC (17b) may be provided in a video feed of the event, which upon approval by the confirmation feature (605) enables the user to acquire an NFT. Such MRCs (17b) may be provided in or as an overlay on a live video feed for an event being broadcast over the Internet, network, cable television, or the like. For example, a network broadcast of the Superbowl, may contain a tag (16b)/MRC (17b) in the lower righthand corner of the video feed. This tag could be the same tag for every viewer or different tags could be visible to different geographic regions as determined by the administrator, owner of the tag, or entity with the broadcasting rights.

The NFTs made available for acquisition, may include any number of NFTs for a particular event. The NFT offered via the video feed may be the same as or different from the NFT offered to in-venue users. Furthermore, multiple different NFTs may be provided and offered for acquisition based upon geographic location. Thus, the NFT offered to a remote user watching the live video in Philadelphia may be different from the NFT offered to a remote user watching in Dallas.

Additionally, the administrator has the ability to set an infinite number of variable parameters that must be met before the confirmation module (605) give approval. For example, if one tag (16b)/MRC (17b) is displayed to a large geographical area, the administrator my use the GPS location of the user device to determine which NFT the user is eligible to purchase. Likewise, the administrator may create a geofence of any area and only offer a particular NFT within that geofenced location, as has been detailed with respect to FIGS. 7 and 8. If multiple tags are used for video feeds in different regions, the administrator may still require a second level of authentication by having the platform (20)/confirmation module (605) check the GPS location of the user device (14b) that scanned the tag (16b). This would eliminate the ability for one user to send a photo of his tag (16b) to a user in another region and also eliminate the ability for a user to share a video feed with another user over a peer-to-peer connection like Facetime, Zoom, Twitch, or via social media such as Instagram, snap chat, Facebook, twitter, or any other video sharing site. The administrator may define further parameters that must be met in order to verify that a user is entitled to acquire an NFT such as requiring the timestamp (318) of the scan to be within the time parameters during which the event was broadcast live or within a certain amount of time after the conclusion of an event. This prevents users from acquiring the NFT based upon scanning a tag (16b) in the replay of the event. In order to effectuate this embodiment, the confirmation feature (605) may call on/utilize information from one or more steps from a method that is the same as or substantially similar to method (400). Furthermore, the confirmation feature (605) may utilize any other method, in whole or in part, described herein and data needed to determine if the user device (14b) has meet the threshold of variables established by the administrator. If yes, the platform (20) enables the acquisition module (615) as described in detail above and the user is permitted to mint, purchase, bid-on or otherwise acquire the NFT.

EXAMPLE 8: Sometimes the importance of an event is not apparent until later after the event has occurred. As one example, a famous band finishes their tour and two months later a band member dies. As another example, famous a band may hold a live concert with no intention of it being their last concert but months later the band may unexpectedly break-up or a band member may leave thus giving new meaning to the attendees at that now final concert. Similarly, a star athlete may be tragically killed during the prime of his career thus giving new significance to the last game he played which is now his final game. In these examples, users who may not have purchased an NFT during an event to commemorate their attendance at the event which at the time seemed quite ordinary, may now want to retroactively purchase an NFT as a keepsake or for future collectable value.

In this example, platform (20) queries events record e.g., stored in database (308) or other suitable storage to identify the event that has now become significant. For example, after Rolling Stones' drummer Charlie Watts passed away in 2021, the Aug. 30, 2019, at the Hard Rock Stadium in Miami became historically significant as his last concert. The platform (20) then queries the tag ID for each seat located at the particular venue. Next, the platform (20) queries the database (308) or other data store, to identify the unique ID of all user devices (14a) that scanned a tag (16a) while the event was in progress, which in this example, was Aug. 30, 2019, between 7:00 pm and 11:00 pm. Next, the platform (20) may query the user record associated with unique ID and cross references other verification datapoints and API calls such as whether a digital ticket was stored in the digital wallet (24a) of the user device. Once all of the confirmation features established by the platform (20) or an administrator have been met, the user is permitted to mint, purchase, bid-on or otherwise acquire an NFT as described herein, to the extent that one is offered or is made available.

Example 9. In certain embodiments, the right to acquire an NFT may require some element or actions by the user such as those designated by a particular event/venue sponsor. As such, the event, venue, proprietor, or the like may provide engagement opportunities such as via the portal such as the fan portal (218), one or more Web pages, push notifications, or the like. For example, a hotel may enable engagement opportunities such as checking out of the hotel, ordering room service, purchasing merchandise, and the like, whereas a campus may include engagement opportunities such as buying tickets to a game or an event, registering for free events, taking polls, creating study groups, and the like. And a stadium or concert may detail purchase of food or novelties, placing a wager, or engaging with other features in a pushed Web page. As expected, engagement opportunities may vary widely between industries and sponsor types. Nonetheless, the user, via user device (14a, 14b) may have to satisfy the elements/actions before being approved by the confirmation module (605). As one non-limiting example, only those users who have purchased food, or a novelty, placed a wager, or purchased some item will be approved to acquire an NFT via the acquisition module (615)/method 1100.

Example 10. Certain embodiments may tie the acquisition of an NFT to a benefit such as an upgrade to a better seat, lounge access, unlimited food and drinks, or other such benefit as the proprietor, venue, or event prescribes. For example, purchasing an NFT, winning an NFT auction, or approving a winning NFT may come with access to a VIP lounge, even if the user's original seat was not in a VIP section. In each case, the confirmation feature (605) would be configured to ensure that the user was entitled to the NFT, hence the benefit. For example, in addition to the preliminary place and time performed during method (400), the configuration feature may also ensure that the user was entitled to sit in the seat tied to the benefit thereby calling on a seat verification method such as one that is the same as or similar to method (900). Of course, the confirmation may also call on a method such as method (800), to ensure the user device (14a) is within a predetermined geofence (316).

Example 11. The subject matter of the NFT may include a tag (16b) with a functional MRC (17b) so that the user who acquires the NFT will also acquire the target to which the NFT tag is tied. As one non-limiting example, the subject matter of the NFT may include a tag that, when scanned by the user device (14a, 14b) links the user device to a commemorative digital event program having unique content such as video clips, images, and interviews of key people all related to the event that the user attended, watched on a video feed, or the like. Since the subject matter and/or the digital event program may have significant collectable value, the confirmation feature (605) may be configured to approve the acquisition of the NFT only upon heightened approval such as the user device (14a) by being within a geofence (316) per a method such as method (800) and/or a seat verification method such as method (900). Furthermore, an administrator may attach one or more conditions to confirmation feature (605) approval such as the NFT is only available to user device (14a) that have fulfilled a task such as attending three separate events hosted by the proprietor, as one non-limiting example. Indeed, preferred embodiments often require a complex set of rules or obligations to be met, in order to qualify for the right to purchase an NFT that yields some supplemental benefit. Proprietors will recognize that events that engage with fans and force them to participate in or find certain elements to win a prize, are the most loyal fans. Thus, such events can both incentivize participate and also engage fans with content.

Example 12. Certain NFTs, in an embodiment, may be dynamically priced, which in turn may affect the value of the NFT. For example, if a given number of approved users (e.g., via their user device [14a, 14b]), purchase an NFT, the price of the NFT may increase or decrease. In the instance of a price increase, the NFT may become more valuable as more approved users purchase the NFT, which here can be a partial ownership or sequential NFT, wherein the NFT are sequentially numbered to remain distinct. The first approved users to acquire the NFT get the NFT at a lower price and the users who acquire the NFT later pay a premium on the NFT, similar to the rise in popular stock. In this way, the approved users who purchased the NFT at a lower price may receive a better return on their investment. Since time may be of the essence in such an acquisition, the confirmation feature (605) may be configured to utilize a more sophisticated time confirmation technique than the determination at method (400), that the event is in progress. Furthermore, the NFT acquisition module may be configured to enable a price increase as provided by the administrator such as for every ten NFTs purchased raise the price by X number of dollars, or any other pricing increase scheme.

Example 14. In certain instances, purchasing an NFT for a work of art may be equally or more valuable than the original work of art. In this example, a gallery has artwork on display for purchase. Near each work of art is a tag (16a) which has been assigned a tag ID uniquely coded to that piece. When a user scans the tag (16a) with his user device, the user is redirected to a Web page with purchasing information for the NFT for that particular piece. The number of NFTs available for purchase is determined by the administrator or the proprietor. For example, there may only be one NFT available. Likewise, the purchase price, or alternatively, an auction, is set by the administrator or proprietor, together with any other conditions (i.e., rules) that must be met for the purchase of the NFT. If the user meets rules that are in place, if any, the user is permitted to purchase the NFT.

In the instance of a price decrease, the confirmation feature (605) may be configured to wait to see if N number of devices (14a, 14b) are approved before enabling the acquisition module (615) to offer the NFTs at a lower price. If the N number of devices (14a, 14b), however, are not approved within a given amount of time, then the acquisition module (615) may release the NFTs at a higher price.

Example 13. Similar to Example 12, Example 13 may utilize an escrow-type of pricing where approved user funds are held, but the NFT is only released if the stipulated conditions are met. As one non-limiting example, if 100 users at a Superbowl game sitting in a certain section of the venue commit to purchasing an NFT related to the game by transferring funds for the purchase, then the NFT will be released and the funds deducted from the user's wallet (e.g., 24a or the like). If, however 100 users do not commit to purchasing the NFT, then the held funds may be returned to the user's wallet (24a) or held as a down payment on a future NFT purchase price, auction bid or the like.

Referring back to FIG. 3, the infrastructure detailed therein is exemplary, dividing processing between at least two servers (e.g., redirect/identification server [302] and interface server [306]), but embodiments are not so limited. The numbers and types of servers and software may be scaled up, down, and distributed according to platform (20) demands/needs. Furthermore, more than one virtual machine may run on a single computer and a computer/virtual machine may run more than one type of server software (e.g., the software that performs a service, e.g., Web service, application service, and the like). Thus, in some instances platform (20) may include one computer for all processing demands, and in other instances platform (20) may include several, hundreds, or even more computers to meet processing demands. Additionally, hardware, software, and firmware may be included in or removed from platform (20) to increase functionality, storage, and the like as needed/desired.

Administrator device (12), which is shown in FIG. 1, may be any type of computer such as a laptop computer, desktop computer, tablet, and the like. Similarly, user device (14a or 14b) may be any type of processing device such as a handheld computer (e.g., phone, smartphone, tablet, personal digital assistant), wearable computer (e.g., watch, glasses), or portable computers (e.g., laptop, netbooks). Scanning of the tag (16a, 16b) from the user device (14a or 14b) is performed through near-field communication (NFC) or use of a camera on the user device (14a or 14b) to scan the visible quick response code (QR code). Administrator device (12) and user devices (14a or 14b) typically include a browser application to facilitate communications with one or more servers among other things.

The administrator device (12), user devices (14a, 14b), and servers (e.g., 302, 306, 310, 312, 320, 322, and 324) may each be a general-purpose computer. Thus, each computer includes the appropriate hardware, firmware, and software to enable the computer to function as intended and as needed to implement features detailed herein. For example, a general-purpose computer may include, without limitation, a chipset, processor, memory, storage, graphics subsystem, and applications. The chipset may provide communication among the processor, memory, storage, graphics subsystem, and applications. The processor may be any processing unit, processor, or instruction set computers or processors as is known in the art. For example, the processor may be an instruction set based computer or processor (e.g., x86 instruction set compatible processor), dual/multicore processors, dual/multicore mobile processors, or any other microprocessing or central processing unit (CPU). Likewise, the memory may be any suitable memory device such as Random Access Memory (RAM), Dynamic Random-Access memory (DRAM), or Static RAM (SRAM), without limitation. The processor together with at least the memory may implement system and application software including instructions, including methods, disclosed herein. Examples of suitable storage includes magnetic disk drives, optical disk drives, tape drives, an internal storage device, an attached storage device, flash memory, hard drives, and/or solid-state drives (SSD), although embodiments are not so limited.

In an embodiment, servers (e.g., 302, 306, 310, 312, 320, 322, an/or 324) may include database server functionality to manage database (308) or another database. Although not shown, infrastructure variations may allow for database (308) to have a dedicated database server machine. Database (308) and any other database may be any suitable database such as hierarchical, network, relational, object-oriented, multimodal, nonrelational, self-driving, intelligent, and/or cloud based to name a few examples. Although a single database (308) is shown in FIG. 3, in embodiments database (308) may comprise more than one database, the more than one database may be distributed across many locations, and data may be redundantly recorded in the more than one database. Furthermore, data may be stored in blocks that are part of a chronological blockchain (314) and may be dispersed across a decentralized distributed ledger. Blocks of data in a blockchain are linked in such a way that tampering with one block breaks the chain. Thus, digital data stored in a blockchain is verifiable with an elevated level of integrity. Therefore, the database (308) may also be a distributed database system, utilizing blockchain (e.g., 314) to provide for storage of NFTs or the like related to the system. As with any distributed database, the number of databases and particular nature of the blockchain storage is dependent on the particular exchange or blockchain utilized for the NFT as one non-limiting example. The use of a distributed database system is well known and the storage of an NFT or the like requires the use of such systems. Geofence (316) and Time (318) may be software services provided by the platform (20). These services (316, 318) may be executed by any or all of the computing machines, virtual or otherwise, found on the platform (20). These services may use data from one or more user devices (14a, 14b) and other data sources to provide their intended functionality as is known in the art.

It will be appreciated that the embodiments and illustrations described herein are provided by way of example, and that the present invention is not limited to what has been particularly disclosed. Rather, the scope of the present invention includes both combinations and sub combinations of the various features described above, as well as variations and modifications thereof that would occur to persons skilled in the art upon reading the forgoing description and that are not disclosed in the prior art. Therefore, the various systems and methods may include one or all of the limitations of an embodiment, be performed in any order, or may combine limitations from different embodiments, as would be understood by those implementing the various methods and systems detailed herein.

What is claimed is:

1. A system for verifying a user device and obtaining a right to purchase an NFT comprising:
a. a server system comprising at least one server, at least one database, and at least one user device;
b. a plurality of operable rules populated on said server system wherein said operable rules are met by actions performed by scanning, by the user device, one or more tags positioned within a geofence within a venue;
c. defining at least a first rule wherein said user device confirms ownership of a ticket corresponding to a first tag, said first tag comprising a tag ID defining a specific seat within the venue; wherein the user device confirms ownership by the system after receiving a scan of the first tag by the user device and sends a request to the user device to identify a digital record matching the tag ID;
d. upon meeting the first rule, verifying a location by determining whether the scan by the user device of the first tag was within a geofence corresponding to the venue; and
e. upon verifying the location, redirecting from a server a URL or a Web app to the user device to a page selling or offering for sale the NFT.

2. The system of claim 1 wherein a further rule is required to receive the redirection in step (e), wherein the rule requires that the digital record confirms purchase of a season ticket to the seat.

3. The system of claim 1 wherein a further rule is required to receive the redirection in step (e), wherein the rule defines that the redirection is only available within the first x minutes after an event-related occurrence.

4. The system of claim 3 wherein x minutes is between 1 minute and 60 minutes.

5. The system of claim 3 wherein the event-related occurrence is selected from the group consisting of: a point scored, a game related event, the start of a game, the finish of a game, an occurrence by a given player within a game, scanning by a predetermined number of users of at least one tag within the venue, scanning by a predetermined number of users of at least one tag within the venue wherein the predetermined number of users are active on the system at a given time point, scanning of at least two tags by the user device, scanning of at least two tags wherein each of said two tags are positioned within a different geofence, purchase of an item through the system, placement of a wager on the system, and combinations thereof.

6. The system of claim 1 further comprising a graphical user interface (GUI), said GUI defining at least two tags positioned on a visual map on said GUI, wherein a second rule requires a user to scan the at least two tags defined on said GUI to receive the redirection.

7. The system of claim 1 wherein the NFT comprises a digital image, wherein the digital image within the NFT comprises an operable tag comprising a machine-readable code.

8. The system of claim 1 wherein ownership of the NFT affords a benefit to a user owning the NFT, said benefit selected from the group consisting of: free beverages or food, special rights or entry, specific seat upgrades, backstage access, discounts to tickets, merchandise, other materials at the venue, wagering discount, other tangible benefits that may be given by a proprietor at a given venue, and combinations thereof.

9. A method for authorizing purchase of an NFT comprising:
a. scanning, via a user device, a tag comprising a machine-readable code (MRC);
b. verifying a unique ID on said user device or generating a unique ID if one is not present; and
c. directing the user device to a target URL for purchase of an NFT.

10. The method of claim 9 wherein the tag comprises a unique tag ID that identifies a seat within a venue.

11. The method of claim 10 further comprising a verification step selected from the group consisting of: verifying ownership of a ticket corresponding to the tag, a time verification, a geolocation verification, a predetermined threshold defined by an administrator, and combinations thereof.

12. The method of claim 10 further comprising a verification step, wherein upon scanning the tag in step (a), a server confirms the presence of a digital record corresponding to ownership of a ticket corresponding to the unique tag ID.

13. The method of claim 12 wherein the verification step comprises wherein a server performs an API call to a third party to obtain a digital record confirming ownership of a ticket matching seat information for said tag ID, wherein the digital record is selected from the group consisting of: a digital ticket, a phone number, a credit card, an address, a name, a birthday, another personally identifiable information, and combinations thereof.

14. The method of claim 12 further comprising matching a unique tag ID with a physical ticket.

15. A method for purchasing an NFT from a tag comprising:
a. scanning, via a user device, a tag comprising a tag ID, said tag positioned on a seat and comprising a tag ID identifying said seat;
b. verifying a unique ID on said user device by requesting from a server a matching unique ID within a database or generating a unique ID if one is not present;
c. verifying ownership of a ticket on said user device, said ticket matching the seat defined by said tag ID; and
d. directing the user device to a target URL for purchase of an NFT.

16. The method of claim 15 further comprising a verification step selected from the group consisting of: a time verification, a geolocation verification, a predetermined threshold defined by an administrator, and combinations thereof.

17. The method of claim 15 wherein the step of verifying ownership of a ticket on said user device is performed wherein upon scanning the tag in step (a), a server confirms the presence of a digital record corresponding to ownership of a ticket by a digital record stored on said user device corresponding to the seat and the tag ID.

18. The method of claim 15 wherein the step of verifying ownership of a ticket on said user device is performed by utilizing an API call to match a digital record on the user device to an authorization for the ticket at the given tag, wherein the digital record is selected from the group consisting of: a digital ticket, a phone number, a credit card, an address, a name, a birthday, another personally identifiable information, and combinations thereof.

19. The method of claim 15 further comprising:
c2. determining that the user device is within a predetermined geofence.

20. The method of claim 15 further comprising:
c2. confirming the presence of a first scan of a tag corresponding to a tag ID and performing a second scan of the same tag on a different day than the first scan.
